(19) United States
(12) Patent Application Publication
(10) Pub. No.: US 2003/0028467 A1
(43) Pub. Date: Feb. 6, 2003

(54) Method of raising capital for early stage companies through broker-dealer

(75) Inventor: Jeffrey A. Sanborn, Chesapeake, VA (US)

Correspondence Address: BURNS DOANE SWECKER & MATHIS L L P, POST OFFICE BOX 1404, ALEXANDRIA, VA, 22313-1404, US

(73) Assignee: Front End Capital LLC, Chesapeake, VA

(21) Appl. No.: 10/259,485

(22) Filed: Sep. 30, 2002

Related U.S. Application Data
(63) Continuation of application No. PCT/US01/10459, filed on Apr. 2, 2001.
(60) Provisional application No. 60/193,364, filed on Mar. 31, 2000.

(51) Int. Cl. G06F 17/60

(52) U.S. Cl. 705/36

(57) ABSTRACT

A method and system of raising online venture capital in the private equity and debt markets, for raising capital for early stage, primarily privately held, companies through a broker-dealer and private funds which attempts to maximize the number of investors and a low per unit investment cost to provide wider participation in the private equity market while promoting diversification of risk.

### FIELD OF THE INVENTION

This invention relates generally to a method and system of raising capital, and more specifically to a method of raising online venture capital in the private equity and debt markets, for raising capital for early stage, primarily privately held, companies through a broker-dealer and private funds.

### BACKGROUND OF THE INVENTION

1. Traditional Barriers to Access to Capital Markets

Historically, with regard to companies seeking capital, access to capital, especially seed and early stage capital in equity form, has been limited to those with access to informal networks of friends, family, wealthy individuals, and classic venture capital resources. With regard to investors, access to potential private investment opportunities, as a result of minimal networking opportunities and limitations imposed by state and federal securities regulation, has traditionally been limited to high net worth or high income “accredited” investors. As defined by the United States Securities and Exchange Commission (the “SEC”) in the year of the filing of the present application, with respect to individual investors, accredited investors meet at least one of the following criteria: a net worth of at least $1 million either individually or jointly with the investor's spouse, an individual income of $200,000 for at least the last two years, and a joint income of at least $300,000 a year for at least the last two years. Further, traditional privately-placed securities offerings directed solely to accredited investors often require minimum investments in the range of $50,000-$100,000 or more. Most private securities offerings are undertaken in reliance from the exemption from federal securities registration requirements provided in SEC Rule 506. Naturally, these criteria for accredited investors greatly limit both the pool of possible investors and the amount of money that may otherwise be made available for early stage companies.

2. The Present U.S. Online Venture Capital Market and its Regulatory Basis

In response to some of the traditional barriers to access to capital markets described above and advances in technology, the United States' “Online Venture Capital Market” was born in December, 1996, when IPOnet conducted the first Rule 506 securities offering on the Internet. The SEC, recognizing changes in technology and responding to innovation in the marketplace, has recognized and approved of the use of the Internet and online communications to undertake privately-placed securities offerings through the issuance of SEC No-Action Letters and Interpretive Releases. Such securities offerings may be made in the United States by companies issuing securities directly, by broker-dealers, and by managers of private funds. See “The Expansion of the General Solicitation Rule of the 1933 Act,” Renae Meltzer and Leo Feldman, The Florida Bar Journal, June 1999; “Angels on the Internet: The Elusive Promise of ‘Technological Disintermediation’ for Unregistered Offerings of Securities, Donald C. Langevoort, JSEBL Vol. 2, Summer 1998; “Brave New World? The Impact(s) of the Internet on Modern Securities Regulation, John C. Coffee, Jr., The Business Lawyer, Vol. 52, Number 4, August 1997; “Private Securities Offerings on the Internet,” Michael D. Stovsky, 1996; Lamp Technologies, Inc., SEC No-Action Letter, 1998 SEC No-Act. LEXIS 615, May 29, 1997; Angel Capital Electronic Network, SEC No-Action Letter, Oct. 25, 1996; IPOnet, SEC No-Action Letter, Jul. 26, 1996 (1996 WL 431821 (SEC); 1996 SEC No-Act. LEXIS 642).

Numerous companies have followed IPOnet in undertaking Rule 506 offerings on the Internet. Garage.com Inc. has assisted early stage companies in raising over $200 million through securities offerings directed to its private network of accredited investors. Other companies employing Rule 506 in securities offerings directed to private networks of accredited investors include Offroad Capital Corp., E*Offering Corp. (acquired by Wit Sound View Group, Inc. effective Oct. 16, 2000), Wit Sound Group, Inc., Virtual Wall Street, Inc./Virtual IPO, Inc. (which undertake public offerings, Regulation A Offerings, and, through its “Private Club”, Rule 506 offerings limited to accredited investors), The New York Private Placement Exchange LLC (which undertakes both Rule 506 offerings directed to accredited investors and secondary resales of restricted securities pursuant to Rule 144), EarlyBirdCapital.com, Inc./EarlyBirdCapital, Inc. (which acquired Angeltips.com in September 2000), AngelStreet.com, Inc./LBL Securities, Inc., UniversityAngels, Inc., WR Hambrecht +Co., Direct Stock Market, BeaconVentureCapital.com/Beacon Global Advisors (which distributes securities through independent broker-dealers, family offices, private bankers, and institutional investors rather than directly to individual investors), and IPO.com/Herringtown.com. Additional companies and organizations, while not effecting securities transactions themselves, allow investors in their online networks to negotiate directly with early stage companies. These companies and organizations include: SeekingCapital.com, AngelSociety.com, Rule506.com, Seedstage.com, Ace-Net, and Vcapital.com.

An understanding of the regulatory framework under which the Online Venture Capital Market as it currently exists in the United States evolved helps to explain its numerous shortcomings. Every offering of securities undertaken in the United States, including offerings undertaken through the Online Venture Capital Market, must either be registered with the U.S. Securities and Exchange Commission and all applicable state securities administrators, or alternatively, be undertaken pursuant to statutes and regulations which exempt the offering from federal and state securities registration requirements. Without registration or an appropriate exemption from registration requirements, investors have a statutory rescission right to a return of their investment with interest. The companies and organizations participating in the Online Venture Capital Market described above rely primarily on the exemption from federal securities registration requirements provided by SEC Rule 506 to offer securities to private networks of accredited investors.

Most privately-placed securities offerings in the United States, and virtually all privately-placed securities offerings undertaken through the United States' Online Venture Capital Market as it currently exists, are undertaken in reliance on SEC Rule 506, which offers three primary advantages as compared to the exemptions provided by SEC Rule 504 and SEC Rule 505, the two remaining exemptions contained in the SEC's Regulation D. First, there is no dollar limit on the aggregate sales price of securities that can be sold pursuant to Rule 506, while SEC Rules 504 and 505 limit the aggregate sales price received by the company issuing securities to $1 million and $5 million, respectively. Second, SEC Rule 506, unlike SEC Rules 504 or 505, not only exempts securities offerings from federal securities registration requirements, but also has the additional benefit, by virtue of the National Securities Markets Improvement Act of 1996, of pre-empting state securities registration requirements and other regulation such that state securities administrators can require nothing more than a copy of the “Form D” notice filing made with the SEC, the payment of a state filing fee, and a consent to service of process. Third, by limiting Rule 506 offerings to “accredited” investors such as individuals having an individual or joint net worth of at least $1 million, an individual income of at least $200,000, or a joint annual income of at least $300,000, or entities with at least $5 million in total assets, companies or broker-dealers undertaking securities offerings can do so without the extensive information disclosure requirements (e.g., without a full-fledged private placement memorandum) applicable to soliciting investments from “non-accredited” investors.

While Rule 506 offers the advantages of having no limit on the amount of securities that can be sold, pre-empting state securities laws, and, when securities offerings are directed solely to accredited investors, its use also imposes certain limitations. The securities acquired by investors in Rule 506 offerings are “restricted” securities, which generally cannot be resold by non-affiliated investors, pursuant to SEC Rule 144(k), until such investors have held the securities for two years. In addition, Rule 506 offerings can only be made to potential investors with whom either the company issuing securities or the broker-dealer undertaking the securities offering has a “pre-existing relationship.” This pre-existing relationship requirement is related Rule 506's ban on general solicitation and advertisement, such as newspaper or open access Internet advertising.

Because of the ban on general solicitation, Rule 506 securities offerings like those undertaken through the Online Venture Capital Market as it currently exists can be undertaken on the Internet only if they are conducted in password protected offerings directed to password holders with whom the company issuing securities or the broker-dealer has a “pre-existing substantive relationship.” Such a pre-existing substantive relationship can be established by asking a series of questions regarding an investor's assets, income, investment experience, etc. Such questions are usually asked in the form of a written (or online) questionnaire. While general solicitation and advertising may be used to identify prospective investors, sufficient time must have elapsed between a respondent's completion of the questionnaire and the contemplation or inception of a particular securities offering undertaken in reliance on regulatory exemptions such as Rule 506 which prohibit general solicitation. Numerous No-Action Letters issued by the United States Securities and Exchange Commission prior to the advent of online private placements of securities have established the parameters governing this principal. See, e.g., Bateman Eichler Hill Richards, Incorporated, 1985 SEC No-Act. LEXIS 2918 (12-03-85), H. B. Shaine & Co., Inc., 1987 SEC No-Act. LEXIS 2004 (05-01-87), Woodtrails-Seattle, Ltd., 1982 SEC No-Act. LEXIS 2662 (08-09-82), and E. F. Hutton & Co., 1985 SEC No-Act. LEXIS 2917 (12-03-85).

Because of the “pre-existing substantive relationship requirement” described above, which requires a lapse between a potential investor's completion of an investor questionnaire and that investor's participation in a securities offering, the Online Venture Capital Market as it currently exists causes participating broker-dealers to deny potential investors access to descriptions of securities offerings being undertaken by such broker-dealers at the time the potential investors complete and submit the investor questionnaire. Instead, potential investors must fill out an online investor questionnaire and wait until a later time to review potential private investments in a two-step process that is not well suited to the instant gratification typically expected by Internet users. This two-step delay is a hindrance to companies and broker-dealers seeking to raise capital in the Online Venture Capital Market.

Lack of liquidity is another hindrance to participation in securities offerings through the Online Venture Capital Market as it currently exists. Once investors purchase securities in such offerings, liquidity is extremely limited because restricted securities purchased in a Rule 506 securities offering must be held for at least two years to be resold by a nonaffiliated investor under Rule 144(k), and, with the exception of The New York Private Placement Exchange LLC's Rule 144-based resale network for restricted securities, little opportunity for matching buyers and sellers of such securities exists. Note that it is not clear whether The New York Private Placement Exchange LLC's Rule 144-based resale network for restricted securities predated U.S. Provisional Application No. 60/193,364 filed on Mar. 31, 2000. While some of the companies and organizations listed above require companies issuing securities to provide ongoing reports to investors, none register or maintain updated registrations with state security law administrators to facilitate resale of the securities under state securities laws.

In addition to lack of liquidity, investors seeking to participate in the Online Venture Capital Market as it currently exists face either difficulty or impossibility in achieving diversification in their investment holdings. It is difficult for investors participating in the Online Venture Capital Market to diversify their holdings without either having substantial investable assets or investing a significant portion of their investable assets in high risk privately placed securities. As noted by Susan Scherreik in Business Week on May 22, 2000, “For every 10 deals venture-capital pros invest in, only two or three may turn out to be home runs. The rest are likely to provide small returns or losses. . . . A drawback to venture investing online is that you won't get diversification unless you can afford several deals.” The minimum investment requirement for investing in any one securities offering undertaken by the current participants in the Online Venture Capital Market is typically $25,000-$50,000. Thus, if an investor wished to invest in 10 companies, he or she would have to invest $250,000 to $500,000. Because of the inherent high risk in investing in privately-placed securities such as those offered in the Online Venture Capital Market, investors may wish to devote only five to ten percent of their investable assets in securities offerings undertaken by participants in the Online Venture Capital Market. Thus, to invest $250,000 to $500,000 in 10 deals and simultaneously devote only five to ten percent of his or her investable assets to high risk privately-placed securities, an investor would have to have investable assets of $2.5 million to $10 million, well above even the SEC's required net worth of $1 million for individual accredited investor qualification. Given its high minimum investment requirements, the Online Venture Capital Market as it currently exists is nothing short of elitist.

Another criticism of the United States' Online Venture Capital Market as it currently exists is that, because of screening criteria and a preference of larger transaction values (typically $3 million or more), the companies and organizations currently participating described above typically do not offer securities on behalf of companies seeking seed or first round financings, but instead offer securities of companies past the seed or first round stage which seek expansion financing rather than start-up funds. The first $1 million in private financing that a company raises is typically the most difficult to secure, and the Online Venture Capital Market as it currently exists is not well-suited to seed and first round financings. In particular, the Online Venture Capital Market as it currently exists is not well-suited to enabling inventors to commercialize their inventions.

In addition to a delay in accessing information on securities offerings, a lack of liquidity in securities purchased, a difficulty in achieving diversification because of high minimum investment requirements, and a lack of focus on seed and first round financings and the commercialization of inventions, the Online Venture Capital Market as it currently exists contains numerous other shortcomings. There is currently no means by which companies wishing to issue securities in exchange for goods and services can do so through the Online Venture Capital Market. Investors wishing to invest IRA or other trust or custodial funds in private securities offerings or to consolidate their private or public IRA or other trust or custodial investments with one custodian or trustee can not do so through the Online Venture Capital Market. Access to professionally-managed private funds is extremely limited in the Online Venture Capital Market. Companies seeking to raise capital through the Online Venture Capital Market are afforded only limited protection with regard to the confidentiality of information distributed to potential investors. Transaction costs associated with online venture investing remain high. Marketing techniques associated with online private securities offerings do not take advantage of technology associated with video attachments to email correspondence. The Online Venture Capital Market does not offer portfolio valuation services to its investors. There is currently no means of allowing investors and investment clubs to compete with one another on the basis of estimated portfolio values. Customer acquisition costs incurred by broker-dealers participating in the Online Venture Capital Market remain high. An effective means of answering the questions of potential investors regarding particular companies and securities offerings could be improved. The present invention addresses the shortcomings in the Online Venture Capital Market described above and offers numerous advantages in the placement of private securities offerings online. These advantages are described more fully below.

### SUMMARY OF THE INVENTION

1. General Summary of the Present Invention

The present invention is designed to remove many of the traditional barriers to access to capital markets and promote the capitalization and growth of successful small businesses much more effectively than the United States Online Venture Capital Market as it currently exists has been able to do. The present invention will open access to private securities offerings to a much wider range of potential investors than the current Online Venture Capital Market as described in the Background section above by employing securities regulations that permit offerings to non-accredited investors and requiring minimum investments of $2,000 or less for direct investments and $10,000 for most fund investments. The present invention will open access to the seed capital and early stage securities markets to a much broader base of entrepreneurs, inventors, and investors, and will provide those who already participate in such markets as investors with a broader base of investment opportunities to consider and a significantly smaller minimum investment requirement. The present invention offers greater liquidity in the securities purchased, maintains updated state securities law registrations, and offers a forum for resale transactions. In short, the present invention offers numerous advantages not present in the current online venture capital segment of the United States private securities market.

The preferred embodiment of the present invention contemplates the operation by a registered broker-dealer of a Web site on the Internet designed to allow investors to review offering materials describing securities offered for sale and, after reviewing such materials, to make investment decisions on-line. Depending on the particular offering and the securities regulations employed, offerings will either be open to public access or restricted to pre-registered “members.” Such members, who will register for membership and provide information related to investment suitability on-line, can optionally receive periodic entertainment-quality emails with graphics and animation, and usually with video attachments featuring the principals or executives of the Company issuing securities, informing them of investment opportunities. The broker-dealer's members will constitute the primary source of investment funds for its securities offerings.

Membership will not be limited to “accredited” investors. Investment opportunities will consist of both direct investments in securities issued by the broker-dealer's clients and investment in small private funds managed by the broker-dealer or third party professional fund managers. Furthermore, the minimum investment on most offerings will be kept at a low level (currently contemplated to be at $2,000 or less for direct investments and $10,000 for fund investments) to encourage investors of all means to participate in offerings.

The present invention contemplates that the broker-dealer will solicit primarily early-stage companies and private funds in need of capital to start building a steady flow of investment opportunities to be offered on its Web site. The broker-dealer will screen business plans, meet with entrepreneurs and fund managers, and, once an agreement to undertake an offering is reached, will structure the offering and prepare offering materials for distribution to potential investors via its Web site. The typical offering size will be $1,000,000, the maximum deal size allowable under SEC Rule 504, the primary federal securities exemption upon which the broker-dealer will rely.

While the preferred embodiment of the present invention was developed under the regulatory landscape described herein, the present invention is flexible and capable of modification depending on regulatory developments. The present invention allows the use of all available exemptions from federal and state registration requirements to meet a broker-dealer's needs. As discussed above, the preferred embodiment of the present invention contemplates that most securities offerings will be undertaken pursuant to a combination of SEC Rule 504's exemption from federal registration requirements and state registration. However, in using the present invention, the broker-dealer must assess its clients' needs and its base of member investors to determine when other exemptions such as SEC Rule 506 (discussed herein), SEC Rule 147 (another federal safe harbor available for intrastate offerings), SEC Regulation A (a federal exemption for securities offerings of up to $5 million often described as a “mini-registration”), and their state counterparts may be used.

### BRIEF DESCRIPTION OF THE DRAWINGS

The present invention will now be described by way of specific exemplary embodiments, to which it is not limited, by reference to the following drawings in which:

FIGS. 1 and la are a flow diagram and a flow chart which illustrate the general process by which investors invest directly in companies, in “microfunds” which in turn invest in companies, and in microfund “funds of funds”, which in turn invest in private funds which ultimately invest in companies;

FIG. 2 is a flow diagram which illustrates the process by which an investor achieves diversification in his or her private equity portfolio by investing in numerous companies through low minimum investment securities offerings undertaken by a broker-dealer;

FIGS. 3 and 3a are a flow diagram and a flow chart which illustrate the process by which a broker-dealer coordinates the offering of securities in an initial issuance market, coordinates the maintenance of updated filings with state securities administrators, and enables investors to achieve instant liquidity through an online resale market;

FIGS. 4 and 4a are a flow diagram and a flow chart which illustrate the process by which potential investors in private securities offerings establish a substantive relationship with a broker-dealer through an on-line application, and then obtain instant access to the broker-dealer's initial issuance and online resale markets;

FIGS. 5 and 5a are a flow diagram and a flow chart which illustrate the process by which a broker-dealer coordinates an equity-for-services market by which companies can purchase services from service providers by making full or partial payment for such services through the issuance of such companies' equity;

FIGS. 6 and 6a are a flow diagram and a flow chart which illustrate the process by which a broker-dealer becomes a custodian or trustee for an investor's IRA or other custodial or trust account, and then invests on behalf of such custodial or trust account directly in private companies, in private funds, in public companies, and in public funds;

FIGS. 7 and 7a are a flow diagram and a flow chart which illustrate the process by which a broker-dealer assists inventors in commercializing their patents or other intellectual property through the injection of seed capital in inventors' companies by an affiliated private fund, the coordination of intellectual property-related services by “IP Service Providers”, and the coordination of securities offerings undertaken on behalf of inventors' companies;

FIG. 8 is a flow diagram which illustrates the process by which a broker-dealer raises money for an affiliated or nonaffiliated “microfund fund of funds”, which in turn invest in, e.g., three or more private funds;

FIGS. 9 and 9a are a flow diagram and a flow chart which illustrate the process by which a broker-dealer establishes confidentiality protection on behalf of companies which it assists in undertaking securities offerings, through the use of confidentiality agreements with investors and confidentiality screening and questionnaires;

FIGS. 10 and 10a are a flow diagram and a flow chart which illustrate the process by which a broker-dealer reduces transaction costs by debiting investment funds directly from an investor's bank account rather than from a credit card or through traditional processing of paper checks;

FIGS. 11 and 11a are a flow diagram and a flow chart which illustrate the process by which a broker-dealer solicits interest in securities offerings it undertakes using email correspondence with video attachments depicting information on companies and their executive officers;

FIGS. 12 and 12a are a flow diagram and a flow chart which illustrate the process by which a broker-dealer offers an investor a portfolio valuation service that estimates the values of holdings of securities in private companies;

FIGS. 13 and 13a are a flow diagram and a flow chart which illustrate the process by which a broker-dealer assists investors in forming investment clubs and initiates competitions in which individual investors and investment clubs compete with one another on the basis of estimated portfolio values;

FIGS. 14 and 14a are a flow diagram and a flow chart which illustrate a means by which a broker-dealer can reduce cash outlays associated with customer acquisition by offering as a promotion securities issued by the broker-dealer to investors who complete investor applications or invest in securities offerings undertaken by the broker-dealer; and

FIGS. 15 and 15a are a flow diagram and a flow chart which illustrate a method by which a broker-dealer undertaking securities offerings through a server-based private network of potential investors responds to inquiries from potential investors within this network related to such securities offerings.

### DETAILED DESCRIPTION OF THE PREFERRED EMBODIMENTS

To more fully appreciate various aspects of the present invention, it is necessary to understand that securities markets are generally heavily regulated by various government authorities. These government authorities through regulations and laws impose burdens on broker-dealers. The extent of the burden is greater or lessor depending on the type of investment, the assumed sophistication of the investor and the perceived risks involved. They are usually geared to provide some protection for investors. Hence, the regulatory scheme imposed by government authorities generally define trigger events and thresholds which, once crossed, impose additional duties of disclosure and other forms of protection that have the effect of increasing transactions costs.

Because of the transactions costs, both imposed by government authorities and by the nature of the relationship, the dealer-broker is highly motivated to seek the fewest number of investors with the greatest amount of capital since each investor represents a unitary transaction cost. The present invention, however, does not follow conventional wisdom, but rather pursues a completely different course. The present invention attempts to maximize the number of investors and minimize the entry level for investment. The present invention represents the democratization of the venture capital market and permits diversification of risk at a much lower total investment level than traditional venture capital markets. To understand the present invention more fully, relevant parts of the regulatory system of the United States is described as an exemplar.

1. Regulatory Basis of the Present Invention

The Online Venture Capital Market as it currently exists relies primarily on SEC Rule 506. The present invention contemplates the employment of a different exemption from federal securities registration requirements, SEC Rule 504, in undertaking securities offerings in combination with other state and federal regulations following a unique method and system which provides a useful, concrete and tangible result of providing investment opportunities, information, calculations, and allocations of funds not previously suggested or contemplated by others.

Rule 504 offerings are limited to $1 million, although an additional $1 million can be raised by the company issuing securities once 12 months have passed since the closing of a previous Rule 504 offering. Successive $1 million offerings can be undertaken without limit provided that at least 12 months pass between each offering. Provided that Rule 504 offerings are registered in the states in which they are conducted (state securities registration is much less expensive and time-consuming than federal registration), they can be undertaken by means of general solicitation in those states via the Internet. Investors in Rule 504 offerings registered pursuant to state securities laws need not be “accredited.”

Importantly, securities issued in Rule 504 offerings, in contrast with those issued in Rule 506 offerings, are not “restricted” securities which must be held for two years prior to resale under SEC Rule 144(k). Provided that such securities have been registered in the state or states in which they are offered, they can generally be resold at any time within the state so long as the initial registration statement is still effective, or alternatively, by means of isolated resale transaction exemptions under state securities laws.

The present invention provides facilitation of resale of securities and the resulting additional liquidity of investors' securities by the registration of securities offerings in the states in which they are sold, and the subsequent maintenance of the initial registration statements by the filing of periodic updates with state securities law administrators. Such regulatory compliance will be accompanied by the distribution of updated information on companies via an online resale market. By these means, the present invention allows investors in privately-placed securities to benefit from much greater liquidity in their investments than the typical private placement investor who has invested in Rule 506 “restricted” securities.

Using the combination of Rule 504 at the federal level and registration “by qualification” at the state level, the present invention allows a broker-dealer to offer securities on its Web site to the general public, without password and pre-existing relationship requirements, in any state in which it is registered as a broker-dealer and in which the offered securities are registered with state securities administrators. State registration is a much less expensive and time-consuming process than federal registration of an initial public offering with the Securities and Exchange Commission. However, the detailed registration statement that must be filed with most states is still a somewhat time-intensive endeavor. To minimize time and efforts related to state registrations, the present invention provides for the optional use of a streamlined process available in many states for the “Solicitation of Interest Prior to the Filing of a Registration Statement.” This process will enable the broker-dealer to assess investor interest in a particular offering prior to expending resources for a full-fledged state registration. Assuming there is sufficient investor interest in a particular securities offering, the broker-dealer would then proceed with full-fledged state registrations.

The present invention may involve a broker-dealer who may, in all likelihood, register many of its securities offerings in fewer than all 50 states. The broker-dealer would comply with guidelines adopted by the North American Securities Administrators Association, which limit access of Web site visitors to those located in the appropriate State, to ensure that it is not deemed to have offered securities for sale in a State in which the securities offered are not registered or exempt from registration requirements. This means simply that if the broker-dealer registers an offering in 10 states and allow only potential investors who live in these 10 states to have access to securities offerings, the broker-dealer will not violate state securities laws, such as is currently done by current participants in the Online Venture Capital Market in Rule 506 Offerings.

The present invention may provide that securities offerings will be structured to ensure that the broker-dealer's clients do not inadvertently become 1934 Act reporting Companies by virtue of having too many securities holders. Generally, this will be accomplished by limiting the number of purchasers in any offering to 500 (or less) and placing contractual limitations on the subdivision of blocks of securities held by any one investor. Subsequent securities offerings undertaken for the same issuing company will involve the sale of new classes of securities so that the number of securities holders in any given class will not trigger 1934 Act reporting obligations.

In connection with the broker-dealer's offerings of securities of internally managed and third-party managed private equity funds, the broker-dealer must comply with both The Investment Company Act of 1940 and the Investment Advisers Act of 1940. The broker-dealer should take steps to ensure that it will be considered neither an Investment Company nor an Investment Advisor required to be registered under the applicable Act, and, in addition, must ensure that none of the private equity funds for whom it offers securities will be considered an Investment Company required to be registered.

Registered broker-dealers are exempt from the registration requirements Investment Company Act of 1940. To ensure that all of the private equity funds for which a broker-dealer offers securities will be exempt from the Investment Company Act of 1940, the present invention contemplates that the broker-dealer will rely on the exemption from registration provided by Section 3(c)(1) of the Act. Section 3(c)(1) exempts any issuing fund beneficially owned by fewer than 100 persons that does not undertake a public offering of its securities. Thus, the broker-dealer could organize a $1,000,000 fund and offer that fund's securities under Rule 504 or 506 to its private group of investors with a minimum investment of $10,000 in an effort to close the fund with fewer than 100 investors. To avoid having ostensibly separate funds “integrated” under the Investment Company Act of 1940 (and thereby exceeding the 100 investor rule), all funds must have different investment objectives, different compositions of portfolio securities, and different risk and return characteristics. Thus, under the present invention, the number of funds that the broker-dealer will be able to manage internally is limited and offerings of securities issued by funds managed by third-party fund managers may be undertaken.

The present invention contemplates that a broker-dealer will organize, both internally and through affiliated third party managers, “funds of funds” which will then invest in other professionally managed private equity funds. Generally, the SEC requires that no private equity fund invest more than 40% of its committed capital in any other private investment fund. To meet the 40% standard, each “fund of funds” must invest in at least three private equity funds. In addition, the fund of funds must not have been organized for the purpose of investing in any particular private equity fund so as not to risk “integration” of the two funds for purposes of the 100 investor rule. To meet this requirement, each fund of funds must be organized such that the fund of funds manager ultimately decides which professionally managed private equity funds in which to invest after the fund is organized. See Private Equity Funds: Business Structure and Operations, James M. Schell, Law Journal Press, 1999; “Private Investment Companies: Exceptions Under Sections 3(C)(1) and 3(C)(7) of the Investment Company Act of 1940, Michael R. Butowsky, October 1999; Cornish & Carey Commercial, Inc., 1996 SEC No-Act. LEXIS 625 (Jun. 21, 1996).”

2. Reducing Minimum Investment Requirements to Enhance Diversification and Participation; Allowing “Non-accredited Investors” to Participate

The present invention is designed to enable a broker-dealer offering securities through the Internet or other means of electronic communications to increase the number of investors participating in any single securities offering to the maximum number feasible under applicable securities laws so that minimum investment requirements can be reduced to their lowest feasible amounts. For example, under current federal securities laws in the United States, a private company which has or could have in the future total assets of $10 million or more must limit the number of holders of any one class of securities to 500 so as not to become subject to the burdensome public reporting requirements under the 1934 Act. In addition, under Rule 504, the maximum size of a securities offering is $1 million. A preferred embodiment of the present invention would thus be to (a) conduct a Rule 504 securities offering with a minimum investment amount of $2,000 ($2,000 * 500=$1 million) or less if distribution data from such securities offerings shows that the average number of investors purchasing securities in increments of more than $2,000 will allow a lower minimum investment amount while still enabling the broker-dealer or company conducting the offering to close $1 million in securities sales with 500 or fewer investors, (b) contractually prohibit investors from subdividing the securities they purchase into multiple units and transferring such units to third parties, and (c) employ advanced database and electronic and other communications techniques to streamline all communications between companies issuing securities and their investors, thus allowing a company to maintain communications with larger numbers of security holders than has typically been the case. A second preferred embodiment of the present invention would use the same principals stated in (a)-(c) above for Rule 504 securities offerings undertaken by or on behalf of private funds exempt from the registration requirements of The Investment Company Act of 1940 under Section 3(c)(1) of the 1940 Act, but, because of Section 3(c)(1)'s 100 investor limitation, would employ a minimum investment amount of $10,000 or less if distribution data from such securities offerings shows that the average number of investors purchasing securities in increments of more than $10,000 will allow a lower minimum investment amount while still enabling the broker-dealer or company conducting the offering to close $1 million in securities sales with 100 or fewer investors.

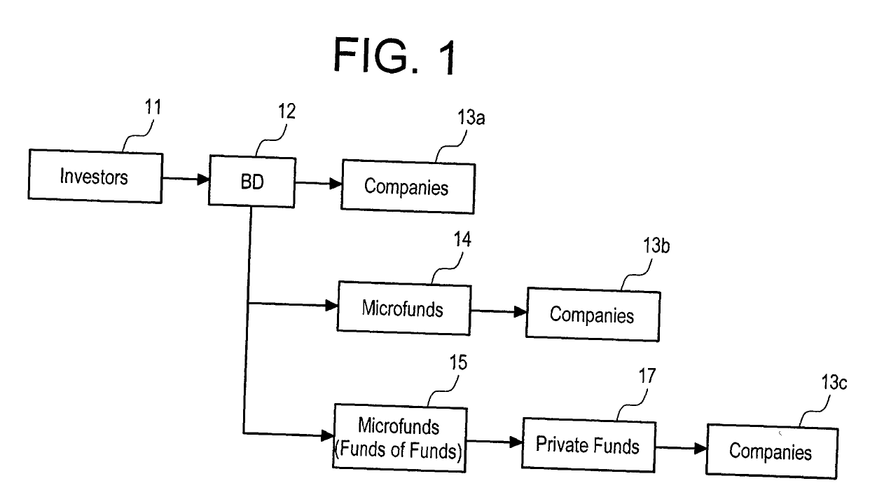

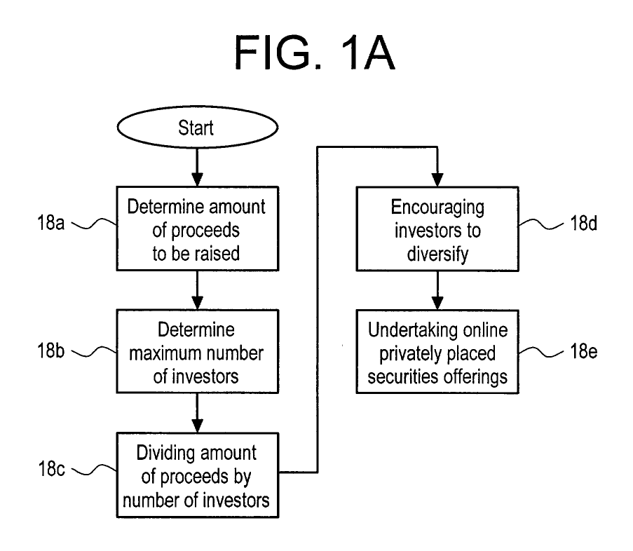

Some of these preferred embodiments are depicted in FIG. 1, with the number of investors 11 being 500 or less for direct offerings by the broker-dealer BD 12 on behalf of companies 13a-13c and or 100 (or less) for offerings by the broker-dealer on behalf of direct investment microfunds 14 and funds of funds microfunds 15. The direct investment microfunds 14 then invest in companies 13b, which may be the same or different companies 13a for which the broker-dealer offers direct investment. The fund-of-funds microfunds 15 invests in private funds 17, which might be the same or different from the microfunds 14, which in turn invest in companies 13c. The companies 13a, 13b and 13c may overlap, be distinct from each other or be the same as each other.

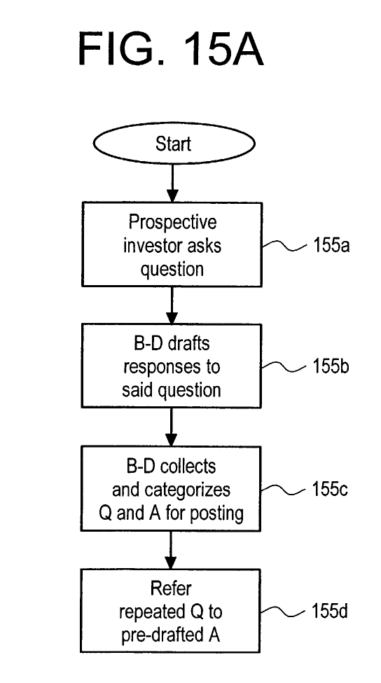

The present invention achieves this goal by providing a method of minimizing minimum investment requirements for privately-placed securities offerings undertaken by broker-dealers using a server 156 (shown in FIG. 15) so as to increase investor participation and minimize investable assets required of investors to achieve portfolio diversification, as shown in FIG. 1a. The method includes, in step 18a, determining the lesser of the maximum or the desired amount of proceeds that the issuing company will raise under applicable securities regulations or business criteria and, in step 18b, determining the maximum number of investors to whom the issuing company will issue securities under applicable securities regulations. Then, in step 18c, the method includes dividing the determined amount of proceeds from step 18a by the maximum number of investors determined in step 18b to determine a minimum investment requirement for the securities offering, thereby maximizing the number of investors permitted to invest in the securities offering and simultaneously minimizing the minimum investment requirement for participating in the securities offering.

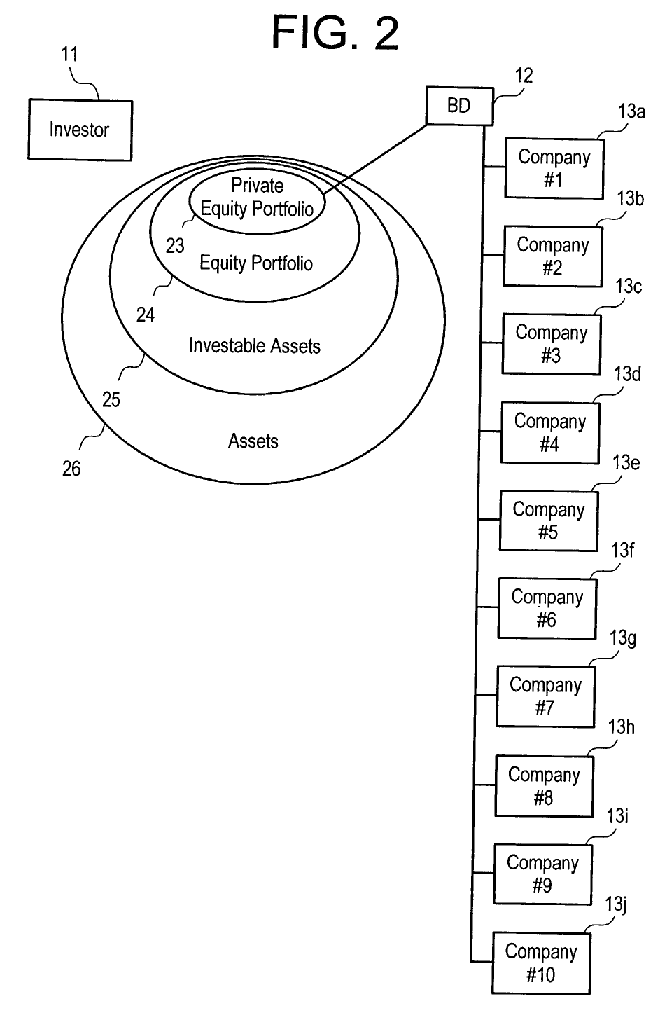

The ease of diversification available to investors through the broker-dealer's 12 use of such preferred embodiments is depicted in FIG. 2, which illustrates the process by which an investor 11 achieves diversification in his or her private equity portfolio by investing in numerous companies 13a-13j, through low minimum investment securities offerings undertaken by the broker-dealer BD 12. Hence, the present invention includes a step, step 18d of FIG. 1a, for encouraging potential investors to diversify their portfolios of privately-placed securities by dividing the amount that they wish to invest in such portfolios into as many different investments as possible given the minimum investment requirement determined in step 18c. Further, the method includes step 18e of FIG. 1a of undertaking the online privately-placed securities offering structured as prescribed by steps 18a-c by soliciting purchase orders for securities through its base of online investors acquired by the broker-dealer.

The preferred embodiments of the present invention, by enabling such diversification, meet an unfulfilled need in the online venture capital market as it exists today. As noted by Susan Scherreik in Business Week on May 22, 2000, “For every 10 deals venture-capital pros invest in, only two or three may turn out to be home runs. The rest are likely to provide small returns or losses . . . . A drawback to venture investing online is that you won't get diversification unless you can afford several deals.” The present invention reduces the cost of such 10-deal diversification to $20,000 or less for example, while the typical cost of such 10-deal diversification in the on-line venture capital market as it exists currently is $250,000 $500,000 because minimum investments typically range from $25,000-$50,000.

Returning to FIG. 2, an investor's 11 private equity portfolio 23, which, because of the high risk inherent in private equity securities may comprise only 5% of his or her investable assets 25, can be diversified by means of investments in 10 private companies 13a-13j, for instance, offering securities through the broker-dealer 12 using the present invention. As illustrated in FIG. 2, the investor 11 has total assets 26 of which a certain portion is considered to be investable assets 25. Within the total investable assets 25, only a portion would be within an equity portfolio 24, and of those, only a fraction is contemplated to be part of a private equity portfolio 23. The present invention solves the perceived problem of diversifying the private equity investment portfolio 23. Again, because of the, e.g., $2,000 or lower minimum investment in the present invention, the cost of such 10-deal diversification is $20,000 or less, and an investor wishing to limit the size of his or her private equity portfolio 23 to 5% of his or her investable assets can have investable assets of as little as $400,000 and still achieve this goal. To achieve such diversification (private equity portfolio of 10 deals comprising 5% of total investable assets) in the current on-line venture capital market, investors typically must have investable assets of $5 million to $10 million, again because minimum investments typically range from $25,000-$50,000 instead of $2,000 or less as is possible employing the present invention. Note that the present invention is not limited to equity offerings, and that the description and rationale described above and depicted in FIG. 2 would apply to debt offerings by changing 23 to “Private Debt Portfolio” and 24 to “Debt Portfolio.” The combination of the present invention's preferred embodiment of using Rule 504 in combination with the technological solutions through an open (e.g, the Internet) or private network, which allows nonaccredited investors to participate, and a minimum investment much lower than is currently available in the online venture capital market, will make the online venture capital market accessible to many more people than it is currently.

2. Instant Liquidity

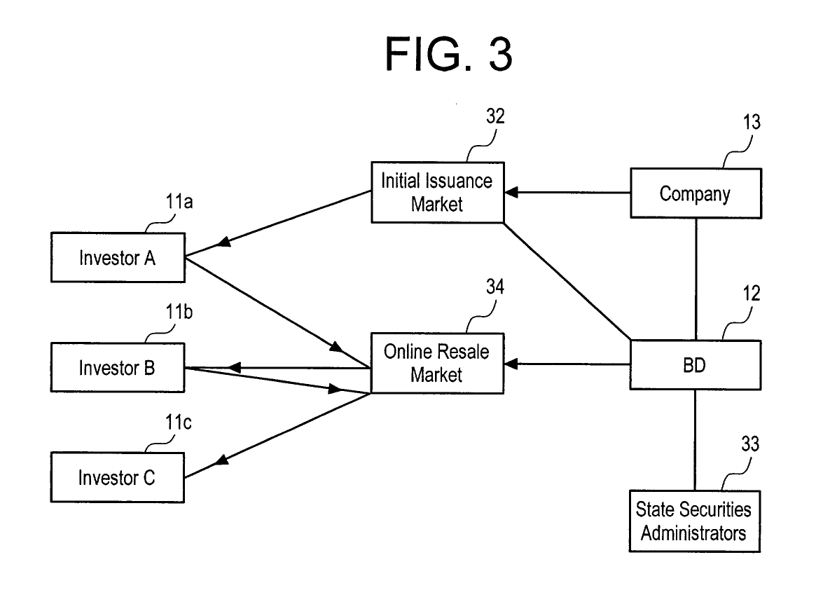

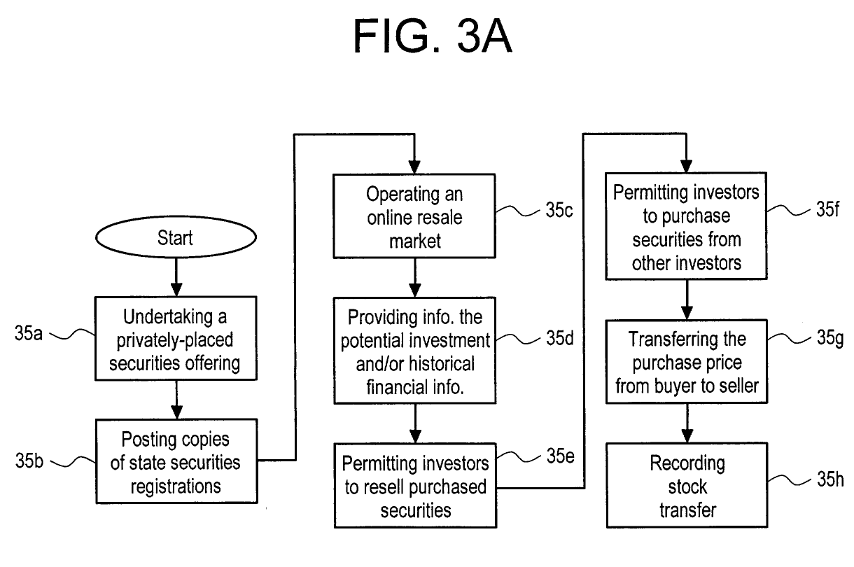

FIG. 3 illustrates the process by which a broker-dealer 12 coordinates the offering of securities in an initial issuance market 32, coordinates the maintenance of updated filings with state securities administrators 33, and enables investors to achieve instant liquidity through an online resale market 34 of securities in a company 13. As discussed above, securities purchased pursuant to Rule 504, unlike securities purchased pursuant to Rule 506, are not “restricted securities.” Thus such securities can be resold immediately provided that the securities are registered with state securities administrators in states in which resales are to occur.

The present invention combines the use of Rule 504 with a system of maintaining updated filings with state securities administrators 33 and disseminating electronic copies of such filings and other information regarding the companies 13 issuing securities (valuations for subsequent securities offerings, financial statements, material events, press releases, etc.) to investors 11a, 11b, 11c as a part of the broker-dealer's 12 operation of an online resale market. Companies 13 issuing securities through the broker-dealer in the initial issuance market 32 will be contractually obligated to cooperate in the broker-dealer's 12 preparation of updated filings with state securities administrators 33 and to provide ongoing supplemental information to be provided in the online resale market 34.

In FIG. 3, a company 13 issues securities through the broker-dealer 12 to an investor A 11a, who purchases such securities through the online initial issuance market 32 maintained by the broker-dealer 12. Investor A 11a then can offer the company's 13 securities for sale on the online resale market 34 maintained by the broker-dealer 12 as described above. Investor B 11b, basing her investment decision on information maintained by the broker-dealer 12 and posted on the online resale market 34, purchases the securities from Investor A 11a. The broker-dealer 12 updates the company's 13 stock ownership records accordingly, and simultaneously updates the portfolio records of both Investor A 11a and Investor B 11b, which can be maintained by the broker-dealer 12 and made available to the investors 11a-11c. Later, investor C 11c might purchase the securities from investor B 11b using the same basic process. All resale prices are posted on the online resale market 34 for the review of other investors 11. The asking prices and the bid prices on the online resale market 34 are determined by investors 11 participating in the online resale market 34 based on such investors' assessment of each company's 13 value using information provided by the broker-dealer 12 as described above.

Hence, the present invention includes a method of providing investors in privately-placed securities offerings undertaken by broker-dealers with instant liquidity in their investments. As illustrated in FIG. 3a, the method includes the steps of undertaking, by a broker-dealer, a privately-placed securities offering (i) using exemptions from federal securities registration requirements (e.g., Rule 504) that do not result in the issuance of restricted securities, and (ii) registering such securities with state securities law administrators (step 35a), and posting, by the broker dealer, copies of state securities registrations and additional information regarding the company in question on its server 156 (shown in FIG. 15) and allows members of its private network of investors to access such registrations and information (step 35b). The inventive method further includes as step 35c operating, by the broker dealer, an online resale market to accommodate resales of securities said broker-dealer has issued.

Furthermore, the inventive method can include the step of providing, at step 35d, the online resale market at least one of the following types of information: (i) information described in step 35b above; and (ii) transaction-based historic price-per-share data including at least one of the price-per-share in the initial securities offering, subsequent rounds of financing, and resales consummated in the online resale market, on the companies featured in the online resale market.

Additionally, the present invention can include as step 35e a step of permitting investors who invest in the broker-dealer's privately-placed securities offerings and desire to resell purchased securities to do so at any time after their initial purchase by either (i) setting an asking price and advertising the securities for sale on the broker-dealer's online resale market or (ii) accepting an offer to purchase posted by another investor. An additional step, step 35f, can be permitting investors who wish to purchase securities in companies featured in the broker-dealer's online resale market to do so by either (i) accepting the offer of an investor who has posted securities for sale as described in step 35e (i) above or 35e (ii) posting a notice on the online resale market describing the company and the amount of securities desired and the price-per-share that the investor is willing to pay for such securities.

As shown in FIG. 3a, the invention can also include step 35g, which involves transmitting, once a resale transaction described in step 35e or 35f is consummated, the purchase price through the broker-dealer's server 156 (shown in FIG. 15) preferably by means of a direct withdrawal from the buyer's bank account and a direct deposit in the seller's bank account, and details regarding the transaction such as the price-per-share, the number of shares sold, and the date of the transaction, are automatically posted on the broker-dealer's server 156 (shown in FIG. 15) as a part of the online resale market. Further, the present invention can include step 35h wherein the broker-dealer or a third party transfer agent cancels the stock certificate of the seller, if certificated, issues a new stock certificate to the buyer, if to be certificated, and updates the company's stock ledger.

The present invention offers investors instant or near instant liquidity in privately placed securities, which is currently unavailable in the online venture capital market. While the New York Private Placement Exchange LLC operates a resale market, this resale market is a resale market for restricted securities rather than nonrestricted securities issued pursuant to Rule 504. Such restricted securities must have been held by the initial Investor (akin to Investor A 11a in FIG. 1) for at least two years prior to resale by a non-affiliate pursuant to Rule 144(k) or for at least one year prior to resale pursuant to Rule 144 in general. Thus, using the present invention, investor A 11a in FIG. 3 can sell securities to investor B 11b immediately upon the purchase of such securities, without any waiting period as would be required if investor A 11a had purchased restricted securities under Rule 506. Note that it is not clear whether The New York Private Placement Exchange LLC's Rule 144-based resale network for restricted securities predated U.S. Provisional Application No. 60/193,364 filed on Mar. 31, 2000 and incorporated herein by reference, which includes Rule 144-based online market for restricted securities in addition to the instant liquidity resale market described above.

3. Instant Access to Securities Offerings

Because of regulatory restrictions on general solicitation, password protected Rule 506 offerings may be undertaken on the Internet only if they are directed to password holders with whom the company issuing securities or the broker-dealer offering securities has a “pre-existing substantive relationship.” Such a pre-existing substantive relationship can be established by asking a series of questions regarding an investor's assets, income, investment experience, etc. Such questions are usually asked in the form of a written (or online) questionnaire. While a broker-dealer may use general solicitation and advertising to identify prospective investors in privately placed securities offerings, sufficient time must have elapsed between a respondent's completion of the questionnaire and the contemplation or inception of a particular securities offering undertaken in reliance on regulatory exemptions such as Rule 506 which prohibits general solicitation. During the interim waiting period described above, prospective investors in securities offered by broker-dealers participating in the online venture capital market may not participate in any securities offering then in progress, and may not even view offering materials related to such securities offerings.

The interim waiting period described above, which affects all broker-dealers offering securities in reliance on regulatory exemptions such as Rule 506 which prohibit general solicitation, is particularly inhibiting to broker-dealers participating in the online venture capital market because visitors to a Web site typically expect instant access to information.

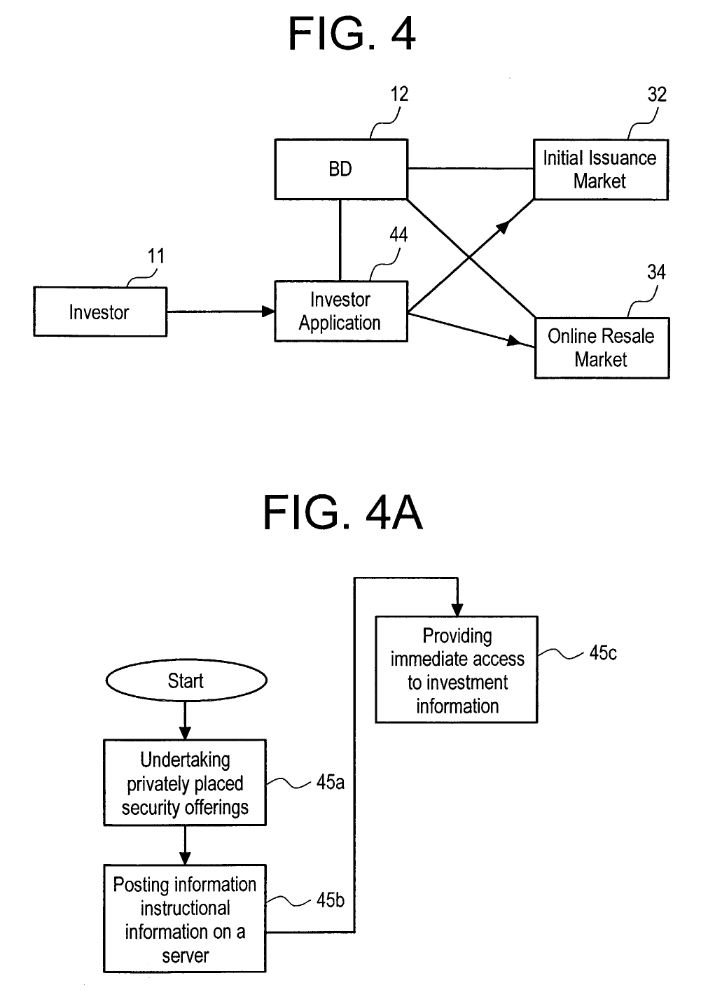

FIG. 4 illustrates the process by which the present invention allows potential investors 11 in private securities offerings to establish a substantive relationship with a broker-dealer 12 through an on-line application 44 and investor questionnaire, and then to obtain instant access to the broker-dealer's 12 initial issuance market 32 and online resale market 34. This process involves the broker-dealer's use of regulatory exemptions such as Rule 504 or Regulation A, as opposed to Rule 506, which is the primary exemption used by broker-dealers participating in the online venture capital market as it exists today.

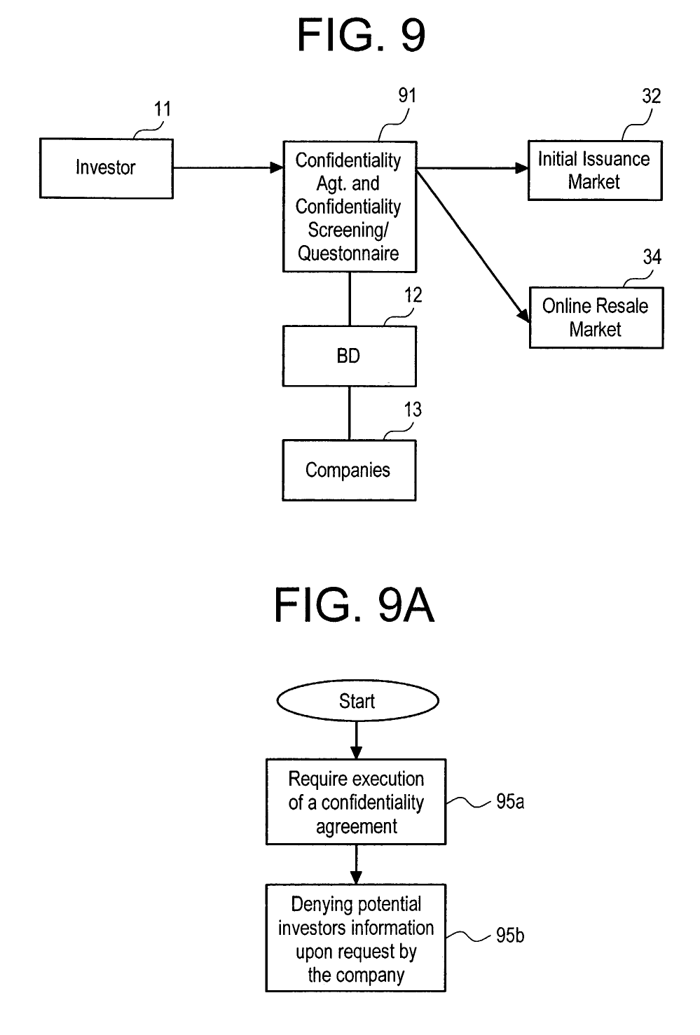

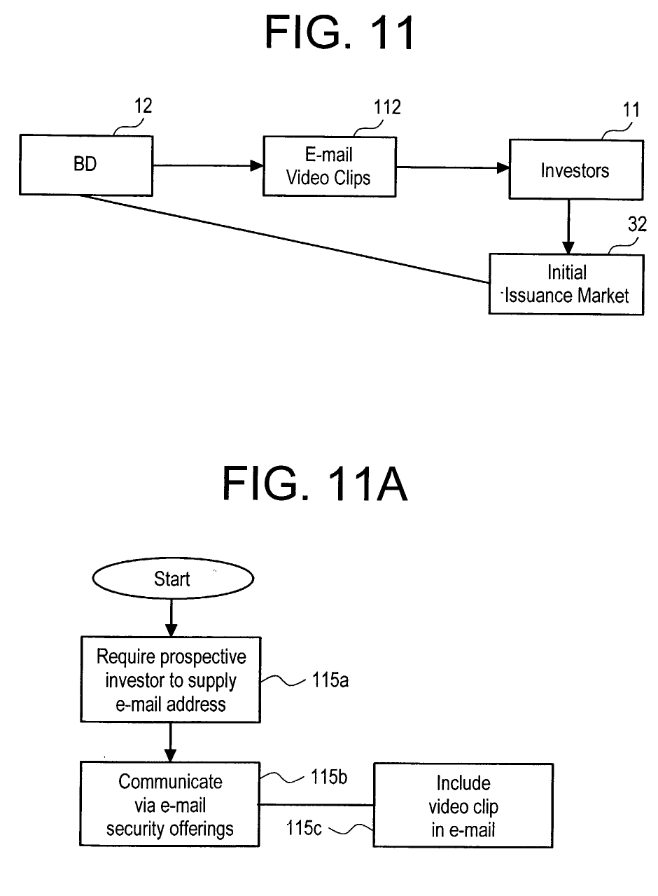

By using regulatory exemptions such as Rule 504 as the exemption from federal securities registration requirements and registering the securities in numerous states to satisfy state registration requirements, the broker-dealer can employ “general solicitation” techniques (Web site posting, unsolicited online communications, advertisements, etc.) to obtain new prospective investors, and can then direct such new prospective investors immediately to the broker-dealer's initial issuance market 32 and online resale market 34. Residents of all states in which such securities are offered would have this immediate access to the initial issuance market 32 and the online resale market 34. The preferred embodiment of the present invention, as depicted in FIG. 4, is to have each prospective investor 11 complete an online investor application 44 including an investor questionnaire and possibly a confidentiality agreement, confidentiality screening/questionnaire 91 following the data flow depicted in FIG. 9, link such prospective investors 11 immediately to the initial issuance market 32 and the online resale market 34, and include such prospective investors 11 immediately as recipients of online communications such as those depicted in FIG. 11.

In FIG. 11, the broker dealer 12 emails to prospective investors 11 information, perhaps in the form of video clips 112, about prospective investments. The potential investor 11 would then have access to the initial issuance market 32, or perhaps the online resale market 34.

An alternate embodiment of the present invention would allow all members of the general viewing public residing within states in which current offerings being undertaken by the broker-dealer 12 are registered to complete a brief questionnaire stating their state of residence, and then have immediate access to materials describing securities offerings being undertaken by the broker-dealer 12 in that particular state. Under this alternate embodiment of the present invention, prospective investors 11 could review the types of securities offerings being undertaken by the broker-dealer 12 prior to establishing a substantive relationship with the broker-dealer 12 by completing an application and investor questionnaire 44 and possibly a confidentiality agreement, confidentiality screening/questionnaire 91.

Hence, as shown in FIG. 4a, the present invention includes a method of providing potential investors in privately-placed securities offerings undertaken by a broker-dealer with instant access to participate in such securities offerings. This method include the steps of undertaking, by the broker-dealer, privately-placed securities offerings (i) using exemptions from federal securities registration requirements such as Rule 504 and Regulation A that allow the “general solicitation” of investors, and (ii) registering such securities with state securities law administrators (step 45a), and in step 45b, posting, by the broker-dealer, information on a server 156 (shown in FIG. 15)instructing prospective investors that have not yet established a substantive pre-existing relationship with the broker-dealer to complete an online investor questionnaire asking questions about each investor's net worth, income, investment experience, etc. so as to enable the broker-dealer to establish a substantive relationship with the prospective investor. The method also includes, in step 45c, the broker-dealer providing, through its server, to such prospective investors, upon completion of the investor questionnaire described in step 45b above, or alternatively, without such completion, with immediate access to information about and the opportunity to invest online in pending privately-placed securities offerings, without any waiting period between the potential investor's completion of the investor questionnaire and his or her participation in the securities offering as an offeree or investor.

4. Equity-for-Services (and Equity-for-Goods) Exchange

Providers of goods and services have sometimes agreed to take, as full or partial payment for their goods and securities, securities issued by their customers. Consulting firms, computer programmers, software providers, marketing firms, branding firms, law firms, investment bankers, printers, vendors or lessors of real property, equipment manufacturers, and many other providers of goods and services have sometimes accepted securities in lieu of or in addition to cash. Many of these transactions are negotiated and documented by attorneys practicing securities law or with the assistance of accountants or other advisors. Many of these transactions, however, are effected without the assistance of securities counsel or other professional advice and guidance. As a result, many of these transactions have taken place in violation of federal and state securities laws and without professional guidance that may be helpful to both parties.

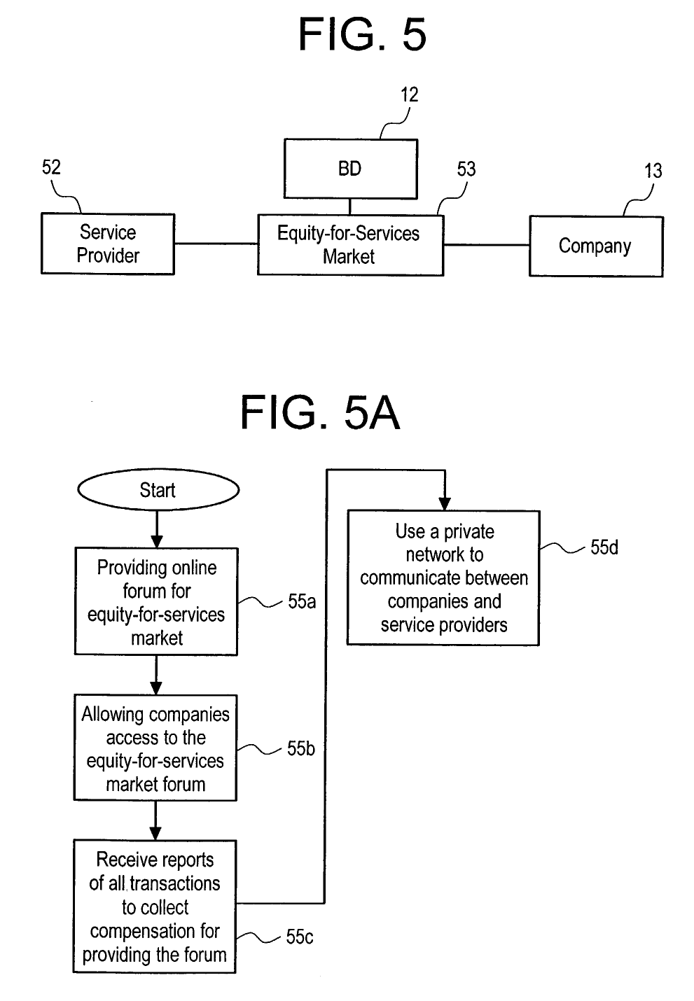

FIG. 5 illustrates the process by the present invention enables a broker-dealer 12 to coordinate an equity-for-services and an equity-for-goods exchange 53 in which companies 13 can purchase services and goods from service or goods suppliers 52 by making full or partial payment for such services and goods through the issuance of such companies' equity (and/or debt) securities. The present invention allows providers of goods and services 52 to advertise their goods and services in an online or other electronic communications-based forum and to specify the types of securities transactions that they will consider as full or partial payment. Companies 13 are able to review the information posted or communicated by such providers 52 of goods and services and choose one or more providers 52 which may suit the company's 13 needs. The company 13 would then negotiate the issuance of its securities to the provider of goods and services 52 as full or partial payment. The broker-dealer 12, whether acting as a pure “finder” that does not play an active role in the negotiation of the securities transaction or acting as a full-fledged broker-dealer 12 negotiating and documenting the transaction, would be compensated by the provider of goods or services 52, the company issuing securities in exchange for such goods or services 53, or both.

The equity-for-services market 53 operated by the broker-dealer 12, in addition to offering information about the providers of goods and services and the terms which they typically consider, would also offer information on regulatory and business issues affecting both companies issuing securities and companies purchasing such securities with goods and services. This guidance would include referrals to legal and other professional guidance to ensure that transactions in which the broker-dealer acts simply as a finder are properly organized and documented.

Hence, the present invention includes a method by which a broker-dealer 12 acts through a server 156 (shown in FIG. 15) as an intermediary for privately-placed securities transactions in which publicly or privately held companies 13 consuming goods and services pay providers 52 of such goods and services either in part or in full with securities issued by such companies 13. This method, as illustrated in FIG. 5a includes the steps of (step 55a) the broker-dealer 12, through its server, providing an online forum for providers 52 of goods and services who are willing to accept full or partial payment for their goods or services in the form of securities issued by companies 13 purchasing such goods or services to advertise their goods and services and terms that they are willing to accept with regard to qualifying companies 13 and, in step 55b, the broker-dealer, through its server, allowing companies wishing to issue securities in exchange for goods and services to access the online forum described in step 55a after registering with the broker-dealer 12 for participation in the online forum.

The method also can include the steps of (step 55c) causing participating companies 13 and providers 52 of goods and services to agree to report all transactions with participants in the online forum to the broker-dealer 12 and to compensate the broker-dealer 12 upon the consummation of a transaction and, in step 55d, initiating contact with one another, whereby participating companies 13 agree to use a private electronic communications network 152 (shown in FIG. 15) operated and monitored by the broker-dealer 12 and to report all resulting transactions to the broker-dealer 12.

5. IRA and other Custodial and Trustee Services

Very few securities brokerage firms are willing or eager to serve as a custodian for IRA accounts or other custodial or trust accounts small amounts of privately issued securities. As of December, 2000, Donaldson, Lufkin & Jenrette, which did offer to act as a custodian for privately issued securities, was an exception. Many firms will act as a custodian for privately issued securities only as a favor to high net worth clients with significant holdings in publicly issued securities, and none attempt to market such services as a revenue-generating segment of their business. In addition, even with regard to holdings in publicly traded securities, investors are often forced to enter into multiple IRA or other custodian or trust agreements for funds managed by different broker-dealers and investment companies. The present invention attempts to solve at least two problems faced by investors: the difficulty in obtaining a custodian or trustee for small holdings of privately-issued securities, and the expense associated with paying multiple parties to act as custodian or trustee for multiple holdings of publicly-issued securities.

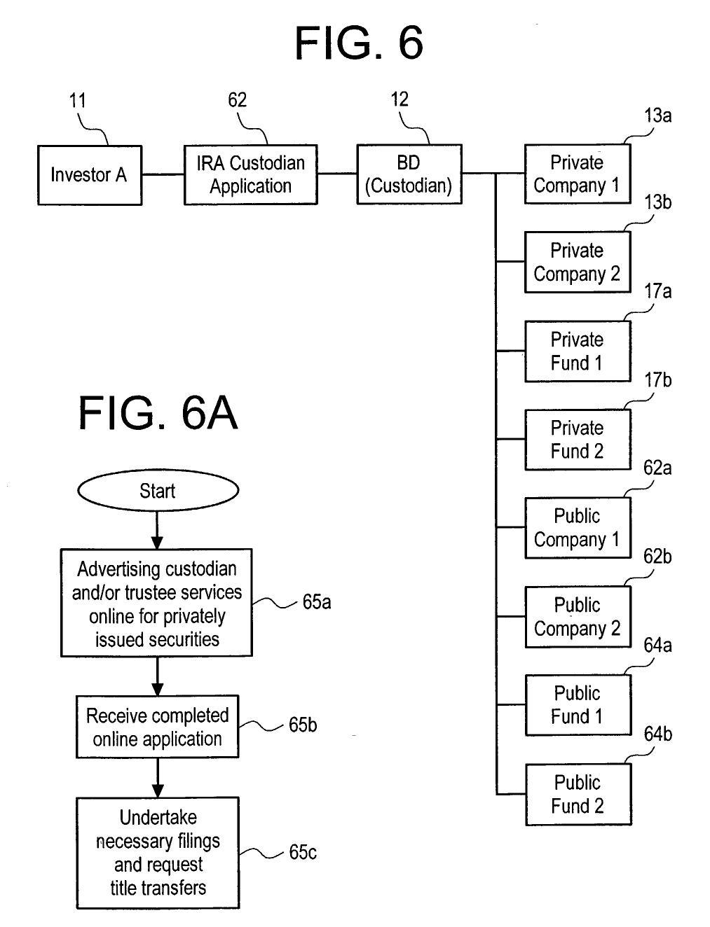

FIG. 6 illustrates the process by which a broker-dealer 12 becomes a custodian or trustee for an investor's 11 IRA or other custodial or trust account, and then invests on behalf of such custodial or trust account directly in private companies 13a, 13b, in private funds 17a, 17b, in public companies 62a, 62b, and in public funds 64a, 64b. This custodial activity would be undertaken on a large scale as a cash generating profit-center using database and electronic communications techniques designed to lower the costs of providing such services. The broker-dealer or other custodian 12 would, by acting as a custodian for multiple accounts, reduce one-time and recurring fees incurred by investors in securities issued or managed by multiple parties.

Hence, the present invention includes a method by which a custodian or trustee acts as a custodian or trustee for privately issued securities and portfolios of publicly and privately issued securities, including securities issued or managed by multiple third parties, so as to lower custodial and trustee fees by consolidating custodial or trustee services from multiple custodians and trustees to a single custodian or trustee. This method, as illustrating in FIG. 6a, includes the steps of a broker-dealer or other entity, through its server, advertises that it will serve as a custodian or trustee for privately issued securities (which is novel as a business segment promoted online) and portfolios of publicly and privately issued securities, including securities issued or managed by multiple third parties (which is novel as a means of consolidating securities holdings managed by multiple third parties into one custodian or trustee), and provides specific instructions to potential customers describing application and related procedures, as illustrated in step 65a. The method also includes step 65b, wherein holders of securities or investors 11 in the broker-dealer's securities offerings complete an online application and submit such online application with personal identification information and information regarding current or prospective securities holdings for which the holder or investor needs custodial or trust services, to the broker-dealer or other entity, as the case may be. Additionally, this method can include step 65c, wherein the broker-dealer 11 or other entity then undertakes all necessary filings and requests for title transfers of securities to become a custodian or trustee.

6. Patent Commercialization Process

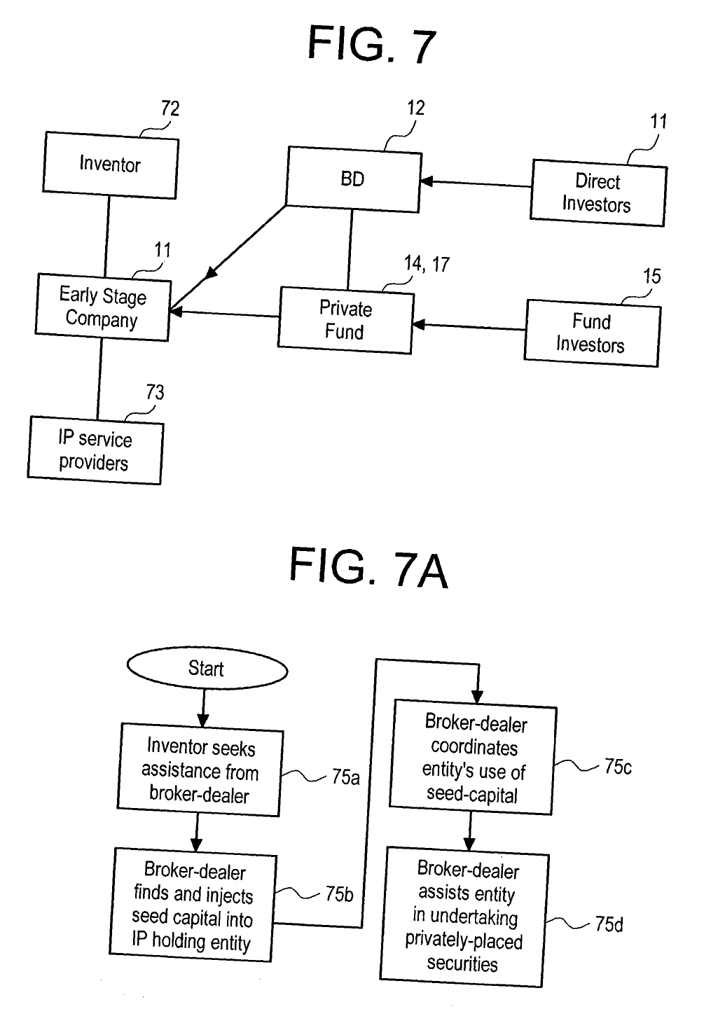

Many inventors today lack the capital required to commercialize their patents. As illustrated in FIG. 7, the present invention allows a broker-dealer to assist inventors 72 in obtaining and commercializing their patents or other intellectual property through the injection of seed capital in inventors' companies by an affiliated private fund 14, 17, the coordination of intellectual property and commercial-related services by “IP Service Providers” 73 (patent law firms, intellectual property law firms, corporate and securities law firms, patent valuation companies, companies providing services related to the negotiation of licensing and other intellectual-property based revenues, accountants, etc.), and the coordination of securities offerings undertaken on behalf of inventors' companies (pursuant to the initial issuance market 32 depicted in FIG. 3). The broker-dealer 12 would coordinate the investments of affiliated and third party private funds 14, 17 through the issuance of equity and debt (unsecured or secured by intellectual property or other assets) in companies 13 to which inventors 72 have assigned patents and other intellectual property rights. The broker-dealer 12 would also coordinate the issuance of equity and debt directly to its network of investors 11, 15. Finally, the broker-dealer 12 would coordinate the services through IP service providers 73 as depicted on FIG. 7 necessary to obtain and/or commercialize an early-stage, intellectual property-based company 13.

Hence, the present invention includes a process by which a broker-dealer, using a server, assists inventors in raising funds through multiple sources to commercialize their patents or other intellectual property rights. The process includes the steps of an inventor seeking assistance from a broker-dealer in raising capital and commercializing his or her patents and intellectual property rights in step 75a of FIG. 7a, and in step 75b, the broker-dealer 11, through an affiliated or third-party managed fund, injects seed capital into an entity formed to hold the inventor's intellectual property in exchange for debt, equity, or a combination of both issued by the entity. The process can also include step 75c, wherein the broker-dealer 11 coordinates the entity's use of such seed capital by the entity for intellectual property and commercial-related services by patent firms, intellectual property law firms, corporate and securities law firms, patent valuation companies, accountants, companies providing services related to the negotiation of licensing and other intellectual-property-based revenue-generating arrangements, etc., so as to prepare the entity for a securities offering. The process also can include in step 75d wherein the broker-dealer assists the entity in undertaking a privately-placed securities offering through its online network of investors, in accordance with the present invention.

7. The “Microfund”

The present invention contemplates a broker-dealer's establishment of numerous microfunds 14, 15, as depicted in FIG. 1, in which a broker-dealer's online investors 11 can invest small increments of money ($10,000 or less). While offerings of securities issued by such microfunds 14, 15 would typically be pursuant to Rule 504, under current SEC regulation, prospective investors 11 may not have instant access to securities offerings as depicted in FIG. 4. Each microfund 14, 15 may be capitalized with $1 million or less, and would be managed either directly by the broker-dealer 12 or by members of the brokerdealer's network of persons or firms who have agreed to manage such microfunds 14, 15 in exchange for cash and equity compensation. Because of the need to limit costs associated with managing such small funds 14, 15, investment criteria would often be tied to due diligence undertaken by third parties or to pre-set, objective criteria. Microfunds 14, 15 would be set up with a wide variety of investment criteria. For example, a microfund 14, 15 may be set up to invest solely in clients of a particular incubator or service provider, to invest only in certain patented technologies, to invest only in certain industries, to invest only in companies headquartered in certain geographic locations, to invest only in companies which have been invested in by certain investors' “dinner clubs,” etc.

One preferred embodiment of the present invention involves the use of a microfund 14, 15 to make a series of investments in seed-stage companies 13 to which inventors 72 have assigned (or will assign) patent or other intellectual property rights. Such microfunds 14, 15 would receive equity issued by such companies 13 in addition to one or more promissory notes issued by such company 13 and secured by intellectual property assigned by the inventor or inventors 72 to the company 13. Such microfunds 14, 15 could be used to provide the company 13 (and its affiliated inventors 72) with the seed capital needed to pay law firms for drafting and prosecuting utility patents, for instance, to organize the company 13 and prepare it for a subsequent securities offering, to pay fees to consultants assisting the company 13 in securing grant funding, etc.

8. The “Microfund Fund of Funds”

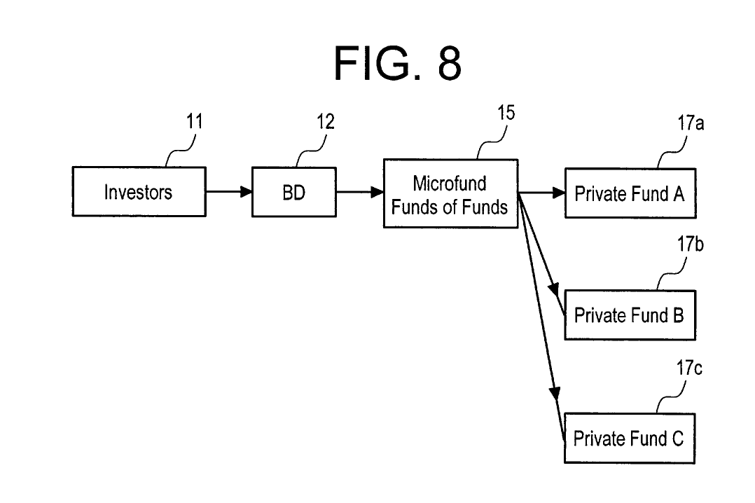

FIG. 8 illustrates the process by which a broker-dealer 12 raises money for an affiliated or nonaffiliated microfund fund of funds 15, which in turn invest in three or more private funds 17a-17c, for instance. The “fund of funds” concept, in which one primary private fund invests in multiple private funds to obtain diversification for the investors in the primary private fund, has long been known. The present invention, however, takes the fund of funds concept one additional step by using a microfund 14 (see Section 7 above) as the primary fund. A preferred embodiment of the microfund fund of funds 15 would involve a microfund capitalized with, e.g., $1 million raised by a broker-dealer 12 pursuant to Rule 504 or an alternate exemption from federal securities registration requirements. The minimum investment would be $10,000. The microfund 15 would typically be open to both accredited and non-accredited investors 11, although certain microfund “funds of funds” would be open only to accredited investors. The entire net amount raised by the microfund fund of funds 15 would be invested in three professionally managed private funds 17a-17c, for instance, with minimum investments requirements of no more than $300,000. Thus, for only $10,000, an investor 11 in one of the broker-dealer's 12 directly managed or affiliated microfund funds of funds 17 could have access to professionally managed private funds 17a-17c that would otherwise require minimum investments of $250,000 or more. Some microfund fund of funds 17 would allow only accredited investors to participate, and proceeds in such funds would be directed to professionally-managed funds which may require that all investors be accredited (the microfund fund of funds would be accredited because all of its investors 11 were accredited, even though its initial assets would be only $1 million, not the $5 million otherwise required of an entity). Other microfund fund of funds 17 would allow non-accredited investors to participate, and proceeds in such funds would be directed to professionally managed funds which allow non-accredited investors 11 to participate (perhaps after being persuaded to by the broker-dealer 12 or fund of funds manager). The microfund fund of funds 17 aspect of the present invention, like many other aspects of the present invention, promotes greater participation in private securities markets by minimizing minimum investment requirements and costs of diversification.

9. Confidentiality Protection for Companies Undertaking Securities Offerings

FIG. 9 illustrates the process by which the present invention allows a broker-dealer 12 to establish confidentiality protection on behalf of companies 13 which it assists in undertaking securities offerings, through the use of confidentiality agreements 91 with investors 11 and confidentiality screening and questionnaires. Such confidentiality protection could be in addition to protection available under patent laws if patents are being pursued. The preferred embodiment of the present invention allows companies 13 for which a broker-dealer 12 undertakes securities offerings to prohibit certain members of the broker-dealer's pool of online investors 11 from accessing information regarding such companies 13 and the securities being offered by requiring each investor to represent in an electronically-generated agreement or questionnaire that the investor does not participate in certain restricted activities designated by the company. For example, a company competing in Industry A with known competitors X, Y, and Z may prohibit access to those members of the broker-dealer's pool of investors 11 who represent that they are involved in the management of competitors X, Y, or X or are otherwise involved in Industry A. Specific criteria for the confidentiality agreement or questionnaire 91 will be developed jointly by the broker-dealer 12 and the company 13 and tailored to the company's needs.

An alternate embodiment of the present invention would provide for periodic updates of the broker-dealer's pool of investors' individual profiles (for example, place of employment, industries in which the investor has an equity or management position, etc.), coupled with the exclusion of prospective investors meeting certain profile-based criteria from specific securities offerings if the company issuing securities deems that prospective investors having such criteria pose a trade secret risk.

Hence, the present invention provides for a method by which a broker-dealer protects confidential information of companies for which it undertakes privately placed securities offerings through a server-based private network of potential investors. This method includes the steps of (step 95a in FIG. 9a) through its server, a broker-dealer requiring, at the same time it collects the information specified in the investor questionnaire described in Section 3 above, that prospective investors to (i) agree to the terms of a confidentiality agreement in favor of it and the companies for which it offers securities; (ii) supply the broker-dealer with information regarding specific companies for which the investor works or holds an executive or equity position; and (iii) supply the broker-dealer with information regarding specific industries (classified by code) in which the investor works or holds an executive or equity position. This method would also include, as step 95b and through its server 156, a broker-dealer denies, at the same time it conducts an online privately-placed securities offering (such as described in sections 1 and 7 above) access to those investors who, based on the information provided to the broker-dealer 12 in step 95a, the company offering securities requests be denied access to information regarding the company and its securities offering.

10. Transaction Processing

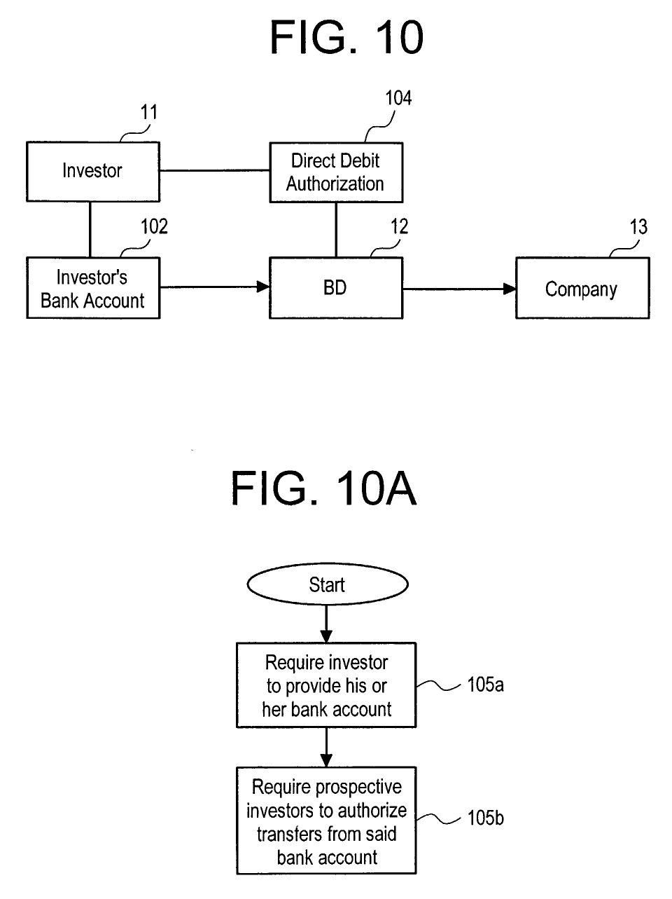

FIG. 10 illustrates the process by which the present invention allows a broker-dealer 12 to reduce transaction costs associated with collecting funds from numerous investors 11 in securities offerings by debiting investment funds directly from an investor's bank account 102 via direct debit authorization 104 rather than from a credit card or through traditional processing of paper checks. This simple procedure makes securities offerings in which as many as 500 investors will participate much less expensive in terms of transaction costs than alternative methods.

Hence, the present invention can include a method by which a broker-dealer undertaking securities offerings through a server-based private network of potential investors reduces transaction costs by debiting investment funds directly from investors' bank account. This method includes step 105a and through its server, a broker-dealer requiring prospective investors to supply the broker-dealer electronically with its bank account and routing information, and in step 105b, through its server, a broker-dealer requires prospective investors to authorize a transfer of the applicable purchase price from the buyer's account to the broker-dealer's account.

11. Video-Enhanced Electronic Communications

In addition to posting information about pending securities offerings on its Web site, the current invention contemplates direct communications, via email and other electronic means, to a broker-dealer's 12 pool of prospective investors 11. FIG. 11 illustrates the process by which the present invention allows a broker-dealer 12 to solicit interest in securities offerings it undertakes using email or other electronic correspondence 112 with video attachments depicting information on companies, their executive officers, and their industries. This enables prospective investors 11 to make investment decisions based not only on a company's business plan and other data, but also on a company's presentation in video format. While certain broker-dealers 12 participating in the online venture capital industry offer “video road shows” in which video presentations are broadcast using Web costing techniques to prospective investors, the inventor knows of no participant in the online venture capital industry that employs short video clips attached to email or other electronic communications 112.

Hence, the present invention provides a method by which a broker-dealer undertaking securities offerings through a server-based private network of potential investors transmits video attachments promoting such securities offerings via email and other means of electronic communication. This method includes the steps of, (step 115a) through its server, a broker-dealer collects, at the same time it collects information specified in the investor questionnaire described in section 3 above, requiring prospective investors to supply the broker-dealer electronically with its email address, and in step 115b through its server, a broker-dealer sends, at the same time it conducts an online privately-placed securities offering as described in sections 1 and 7 above, email communications promoting the securities offering to its registered prospective investors who have supplied the broker-dealer with the investor questionnaire described in section 3 above. The method would further include in step 115c providing email communications promoting the securities offering described in step 115b that would contain an attached video clip including such features as management presentations and information about the company offering securities.

12. Process of Private Equity Portfolio Valuation

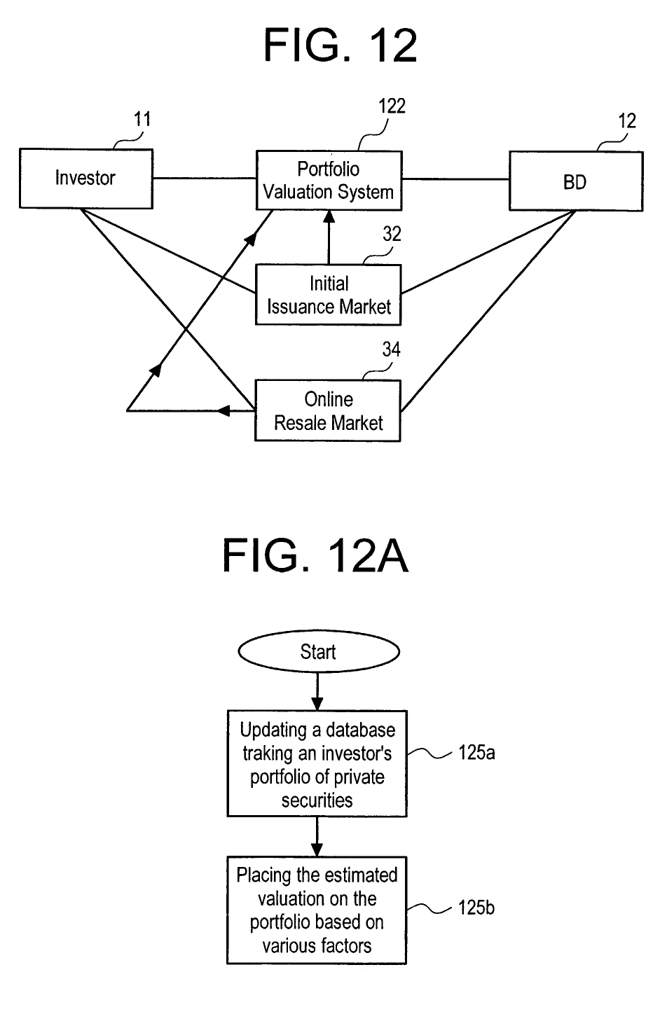

FIG. 12 illustrates the process by which the current invention enables a broker-dealer 12 to offer an investor 11 a portfolio valuation service 122 to its investors 11 which estimates the values of their holdings of securities in private companies 13. This estimated valuation is tied to (a) the initial valuation as used in the company's 13 initial offering in the initial issuance market 32, (b) valuations in subsequent securities offerings, reported by companies in connection with information collected and disseminated in the online resale market 34, and (c) valuations inherent in the prices reported in the online resale market 34 itself (i.e. actual resale prices). While portfolio valuation mechanisms have long been used in the online securities industry with respect to holdings of publicly issued securities, none have been used to value portfolios of privately issued securities.

A preferred embodiment of the present invention would use a range of valuations in determining the value of a particular investor's portfolio in the event that different valuations are reported simultaneously. As an example of the preferred embodiment of the present valuation, if an investor's portfolio consisted solely of 100 shares of Company XYZ purchased at $20 per share on January 1, the investor's portfolio would be valued at $2,000 initially. If, on January 15, the online resale market 34 reported a sale of another investor's shares of Company XYZ at $21 per share, the investor's portfolio would be valued at either $2,100 or at a range of $2,000-$2,100. If, on October 15, Company XYZ issued securities to a venture capital firm at a price of $35 per share, the investor's portfolio would be revalued to $3,500.

Hence, the present invention provides a process of private equity (or debt) portfolio valuation, including step 125a of FIG. 12a, as each investor in securities issued by the broker-dealer purchases securities through online privately-placed securities offering as described in sections 1 and 7 above and purchases and sells securities pursuant to the online resale market described in section 2 above, the broker-dealer, through its server, will update a database tracking the investor's portfolio of securities. This process further includes step 125b, wherein the broker-dealer, through its server, will then place an estimated valuation on the portfolio that is based on (a) the initial valuation as used in the companies' initial securities offering through the process described in section 1 and 7 above, (b) valuations in subsequent securities offerings, reported by companies in connection with information collected and disseminated in the online resale market described in section 2 above, and (c) valuations inherent in the prices reported in the online resale market itself (i.e. actual resale prices).

13. Investment Clubs and Competition for Portfolio Valuation

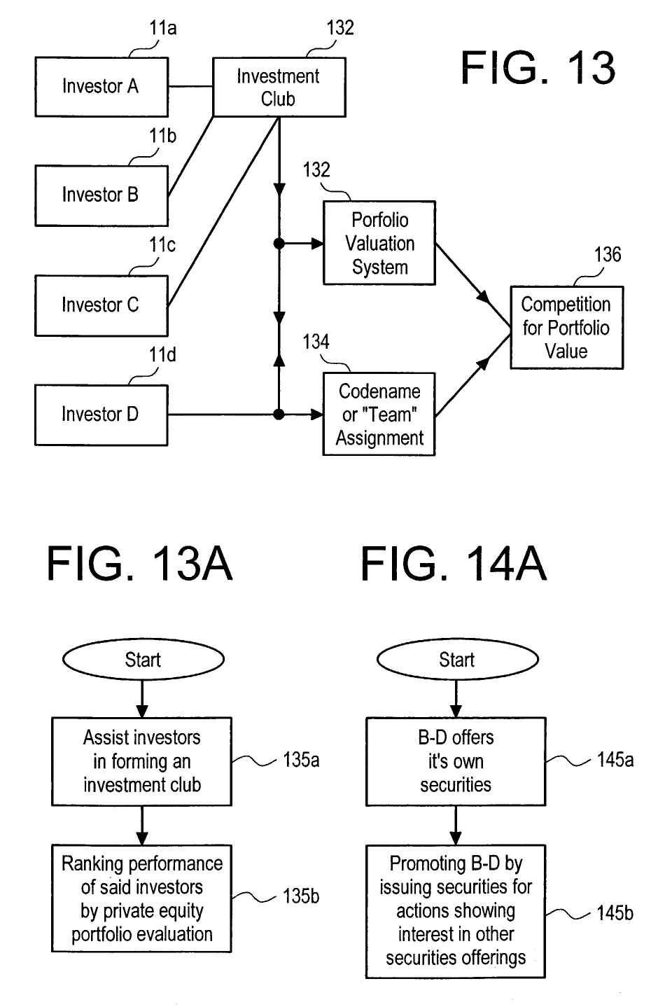

FIG. 13 illustrates the process by which the present invention enables a broker-dealer 12 to assist investors 11a-11d in forming investment clubs 132 and initiates competitions in which individual investors 11 and investment clubs 132 compete with one another on the basis of estimated portfolio values. Individuals 11 and investment clubs 132 have the option of choosing a codename, team name, or other “handle” 134 for purposes of such competition. Participating investors 11 and investment clubs 132 would compete with one another using the portfolio valuation system depicted in FIG. 12 or based on other criteria developed over time. Participating investors 11 and investment clubs 132 would be ranked by performance, and would have the ability to view the portfolios and valuations of other participating investors and investment clubs.

Hence, the present invention provides for a method by which a broker-dealer undertaking securities offerings through a server-based private network of potential investors promotes competition among individual investors and investment clubs for investment performance. This method includes the step of the broker-dealer assisting investors in organizing investment clubs (step 135a if FIG. 13a), and at step 135b using the process of private equity (or debt) portfolio valuation described in section 12 above and other criteria developed over time, the broker-dealer, through its server, coordinates competitions in which participating individual investors and investment clubs are ranked by performance, and have the ability to view the portfolios and valuations of other participating investors and investment clubs.

14. Reducing Customer Acquisition Costs through Securities Offerings

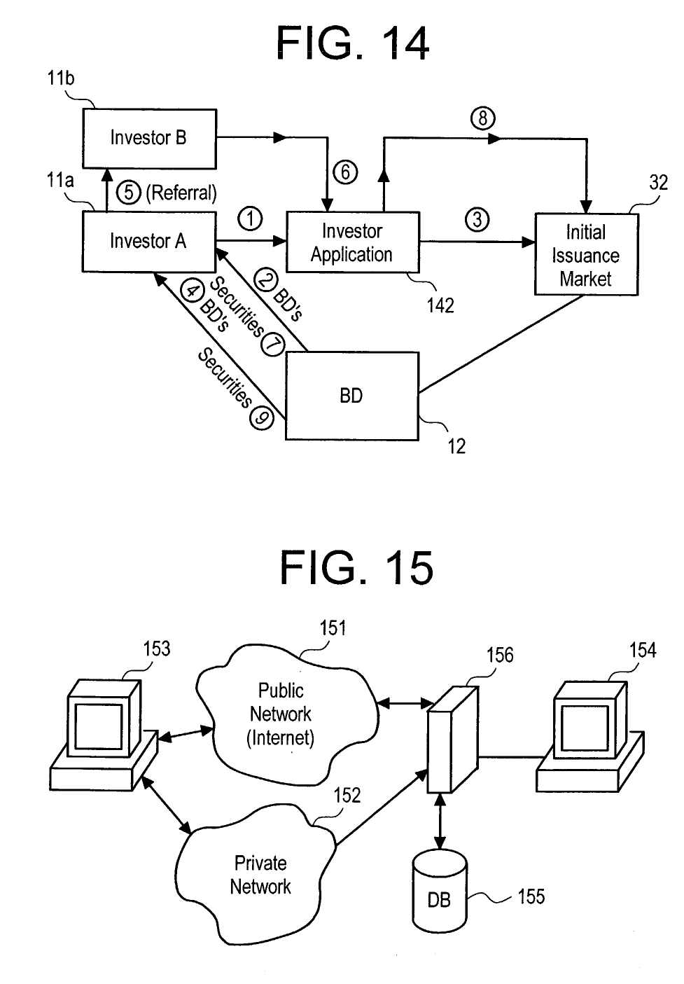

FIG. 14 illustrates a means by which the present invention enables a broker-dealer 12 to reduce cash outlays associated with customer acquisition by offering as a promotion securities issued by the broker-dealer 12 to investors 11 who complete investor applications or invest in securities offerings undertaken by the broker-dealer 12. Such securities offerings must be registered or be undertaken in reliance on exemptions from federal and state securities registration requirements. A handful of companies have registered their securities with the SEC and offered such securities in “free stock” offerings in which securities are issued to persons visiting or registering with the companies' Web sites (see, e.g. Registration Statements filed by YOUNETWORK CORP. and DOCTORSURF.COM, INC. with the SEC in 1999 and 2000). This process has never been undertaken by a broker-dealer 12 for the purposes of building its base of prospective investors 11.

An example of a preferred embodiment of the present invention follows. The broker-dealer 12 registers 1 million shares of its common stock with the SEC for distribution pursuant to its customer acquisition program. The broker-dealer 12 then commences a promotion on its Web site which allows a prospective investor 11a (“Investor A” in FIG. 14) to receive 1 share of common stock for completing an investor questionnaire (“Investor Application” in FIG. 14), 1 share of common stock for referring the broker-dealer 12 to another prospective investor 11b (“Investor B” in FIG. 14) once that prospective investor 11 completes an investor questionnaire, 2 shares of common stock for investing in one of the broker-dealer's securities offerings, and 2 shares of common stock for referring the broker-dealer 12 to another prospective investor 11b (“Investor B” in FIG. 14) once that prospective investor invests in one of the broker-dealer's securities offerings.

Hence, the present invention provides for a method by which a broker-dealer 12 undertaking securities offerings through a server-based private network of potential investors 11 can reduce customer acquisition costs associated with increasing such a private network by issuing its own securities to persons and entities joining and investing through the private network. This method includes the steps of the broker-dealer registers a securities offering of its own securities or obtains exemption from state and federal registration requirements (Step 145a in FIG. 14a), and in step 145b the broker-dealer then organizes a promotion in which members and prospective members of its online investor network receive securities issued by the broker-dealer in exchange for actions such as completing an investor questionnaire, investing in a securities offering undertaken by the broker-dealer, and referring the broker-dealer to a third party who then completes an investor questionnaire or invests in a securities offering undertaken by the broker-dealer.

15. A System for Carrying-Out the Present Invention

The present invention can be carried out over a private network 151 such as the Internet, and/or a public network 152, as shown in FIG. 15. A public network 151, such as the Internet, is preferred for most communications. An investor or potential investor 11, via a suitable computer, Web TV or other network compatible device 153 accesses the brokerdealer's 12 Web site via a server 156, for instance, to which a personal computer 154 is connected. Information about potential investments, on-line questionnaires, financial transaction information and authorizations all or selected ones can carried out on-line to help minimize costs. The broker-dealer's 12 Web site would include or link to databases 155 and one or more servers 156 to provide the investor 11 with information, etc. as described above.

The present invention provides a method by which a broker-dealer undertaking securities offerings through a server-based private network of potential investors responds to inquiries from potential investors within this network related to such securities offerings. This method includes the step of, as prospective investors in securities offerings being undertaken by the broker-dealer through online privately-placed securities offerings as described in sections 1 and 7 above, the broker-dealer 11, through its server 156, allows prospective investors 11 to send questions regarding such securities offerings and the applicable companies 13 (step 155a in FIG. 15a). Then, in step 155b, the broker-dealer 12, with assistance from the issuing company 13 as necessary, drafts responses to such questions and responds to the investors 11 posing the questions by email or other electronic communications. In step 155c, the broker-dealer 12 then collects and categorizes questions and answers and posts them in a periodically-updated document made available via a server 156 and Web site or communicated by email or other electronic means to interested potential investors 11. Also, as illustrated by step 155d, if a potential investor 11 asks a question that the broker-dealer 12 has already answered, the broker dealer 12 refers the potential investor 11 to the previously asked question and corresponding response.

The present invention has been described by way of exemplary embodiments to which it is not limited. Variations and modification will occur to those skilled in the art without departing from the scope of the present invention as defined in the claims appended hereto.

What is claimed is:

1. A method of minimizing minimum investment requirements for privately-placed securities offerings undertaken by broker-dealers using a server so as to increase investor participation and minimize investable assets required of investors to achieve portfolio diversification, comprising the steps of:
a. determining the lesser of the maximum or the desired amount of proceeds that the issuing company will raise under applicable securities regulations or business criteria;
b. determining the maximum number of investors to whom the issuing company will issue securities under applicable securities regulations;
c. dividing the determined amount of proceeds from step a by the maximum number of investors determined in step b to determine a minimum investment requirement for the securities offering, thereby maximizing the number of investors permitted to invest in the securities offering and simultaneously minimizing the minimum investment requirement for participating in the securities offering.

2. A method in accordance with claim 1, further comprising the steps of:
d. encouraging potential investors to diversify their portfolios of privately-placed securities by dividing the amount that they wish to invest in such portfolios into as many different investments as possible given the minimum investment requirement determined in step c.

3. A method in accordance with claim 1, further comprising the step of:
e. undertaking the online privately-placed securities offering structured as prescribed by steps a-c by soliciting purchase orders for securities through its base of online investors acquired by the broker-dealer.

4. A method of providing investors in privately-placed securities offerings undertaken by broker-dealers with instant liquidity in their investments, comprising the steps of:
a. undertaking, by a broker-dealer, a privately-placed securities offering (i) using exemptions from federal securities registration requirements that do not result in the issuance of restricted securities, and (ii) registering such securities with state securities law administrators;
b. posting, by the broker dealer, copies of state securities registrations and additional information regarding the company in question on its server and allowing members of its private network of investors to access such registrations and information;
c. operating, by the broker dealer, an online resale market to accommodate resales of securities said broker-dealer has issued.

5. A method in accordance with claim 4, further comprising the step of:
d. providing an online resale market at least one of the following types of information: (i) information described in step b; and (ii) transaction-based historic price-pershare data including at least one of the price-per-share in the initial securities offering, subsequent rounds of financing, and resales consummated in the online resale market, on the companies featured in the online resale market.

6. A method in accordance with claim 4, further comprising the step of:
e. permitting investors who invest in the broker-dealer's privately-placed securities offerings and desire to resell purchased securities to do so at any time after their initial purchase by either (i) setting an asking price and advertising the securities for sale on the broker-dealer's online resale market or (ii) accepting an offer to purchase posted by another investor.

7. A method in accordance with claim 6, further comprising the step of:
f. permitting investors who wish to purchase securities in companies featured in the broker-dealer's online resale market to become buyers by buying securities by either (i) accepting the offer of an investor who becomes a seller by having posted securities for sale as described in step e(i) above or (ii) posting a notice on the online resale market describing the company and the amount of securities desired and the price-per-share that the investor is willing to pay for such securities.

8. A method in accordance with claim 7, further comprising the step of:
g. transmitting, once a resale transaction described in step e or step f is consummated, the purchase price through the broker-dealer's server.

9. A method in accordance with claim 8, wherein said transmitting step further comprising the step of direct withdrawal from the buyer's bank account and a direct deposit in the seller's bank account.

10. A method in accordance with claim 8, wherein said transmitting step further comprising the step of automatically posting details regarding the transaction including information selected from the following group of types of information comprising: price-pershare, number of shares sold, and date of the transaction, on the broker-dealer's server as a part of the online resale market.

11. A method in accordance with claim 8, further comprising the step of:
h. the broker-dealer or a third party transfer agent cancels the stock certificate of the seller, if certificated, issues a new stock certificate to the buyer, if to be certificated, and updates the company's stock ledger.

12. A method of providing potential investors in privately-placed securities offerings undertaken by a broker-dealer with instant access to participate in such securities offerings, comprising the steps of:
a. the broker-dealer undertakes privately-placed securities offerings (i) using exemptions from federal securities registration requirements that allow general solicitation of investors, and (ii) registering such securities with state securities law administrators;
b. the broker-dealer posts information on a server instructing prospective investors that have not yet established a substantial pre-existing relationship with the broker-dealer to complete an online investor questionnaire so as to establish a substantial relationship with the prospective investor; and
c. the broker-dealer, through its server, provides such prospective investors with immediate access to information about and the opportunity to invest online in pending privately-placed securities offerings, without any waiting period between the potential investor's completion of the investor questionnaire and his or her participation in the securities offering as an offeree or investor.

13. A method by which a broker-dealer acts through a server as an intermediary for privately-placed securities transactions in which publicly or privately held companies consuming goods and services pay providers of such goods and services either in part or in full with securities issued by such companies, comprising the steps of:
a. the broker-dealer, through its server, providing an online forum for participating providers of goods and services who are willing to accept full or partial payment for their goods or services in the form of securities issued by participating companies purchasing such goods or services to advertise their goods and services and terms that they are willing to accept with regard to qualifying companies; and
b. the broker-dealer, through its server, allowing companies wishing to issue securities in exchange for goods and services to access the online forum described in step a after registering with the broker-dealer for participation in the online forum.

14. A method in accordance with claim 13, further comprising the step of:
c. participating companies and providers of goods and services reporting transactions with participants in the online forum to the broker-dealer and compensating the broker-dealer upon the consummation of a transaction.

15. A method in accordance with claim 13, further comprising the step of:
d. initiating contact between participating companies and providers using a private electronic communications network operated and monitored by the broker-dealer and to report all resulting transactions to the broker-dealer.

16. A method by which a custodian or trustee acts as a custodian or trustee for privately issued securities and portfolios of publicly and privately issued securities, including securities issued or managed by multiple third parties, so as to lower custodial and trustee fees by consolidating custodial or trustee services from multiple custodians and trustees to a single custodian or trustee, comprising the steps of:
a. a broker-dealer or other entity, through its server, advertising that it will serve as a custodian or trustee for privately issued securities and portfolios of publicly and privately issued securities, including securities issued or managed by multiple third parties;
b. holders of securities or investors in the broker-dealer's securities offerings completing an online application and submitting said online application with personal identification information and information regarding current or prospective securities holdings for which the holder or investor needs custodial or trust services, to the broker-dealer or other entity; and
c. the broker-dealer or other entity then undertaking all necessary filings and requests for title transfers of securities to become a custodian or trustee.

17. A process by which a broker-dealer, using a server, assists inventors in raising funds through multiple sources to commercialize their patents or other intellectual property rights, comprising the steps of:
a. an inventor seeking assistance from a broker-dealer in raising capital and commercializing his or her intellectual property rights;
b. the broker-dealer, through a third-party, injecting seed capital into an entity formed to hold the inventor's intellectual property in exchange for debt, equity, or a combination of both issued by the entity; and
c. the broker-dealer coordinating the entity's use of such seed capital by the entity for intellectual property and commercial-related services by service providers providing services related to intellectual-property-based revenue-generating arrangements so as to prepare the entity for a securities offering.

18. A process in accordance with claim 17, further comprising the step of:
d. the broker-dealer assisting the entity in undertaking a privately-placed securities offering through its online network of investors as described in claim 1.

19. A method by which a broker-dealer issues securities on behalf of private funds designed to minimize minimum investment requirements for investors, comprising the steps of:
a. determining the lesser of the maximum or the desired amount of proceeds that the private fund will raise under applicable securities regulations or business criteria;
b. determining the maximum number of investors to whom the private fund will issue securities under applicable securities regulations;
c. dividing the resulting amount of proceeds from step a by the maximum number of investors in step b to determine a minimum investment requirement for the securities offering, thereby maximizing the number of investors permitted to invest in the securities offering and simultaneously minimizing the minimum investment requirement for participating in the securities offering; and
d. encouraging potential investors to diversify their portfolios of privately-placed securities by dividing the amount that they wish to invest in such portfolios into as many different investments as possible given the minimum investment requirement determined in step c.

20. A method in accordance with claim 19 further comprising the step of
e. undertaking online privately-placed securities offerings on behalf of the private fund structured as prescribed by steps a-d by soliciting purchase orders for securities through its base of online investors acquired by the broker-dealer.

21. A method of providing a fund of funds by which a broker-dealer issues securities on behalf of private funds (funds of funds) designed to minimize minimum investment requirements for investors and to invest funds raised in multiple private funds managed by third party professional fund managers, comprising the steps of:
a. performing the method of claim 19;
b. investing the capital raised by each private fund in multiple professionallymanaged private funds;
c. providing a minimum investment requirement of the fund of funds which is significantly lower than a typical minimum investment requirement of the participating professionally-managed private funds; and
d. the manager of a fund of funds that accepts nonaccredited investors and does not otherwise as a fund meet the definition of an accredited investor under Rule 501 promulgated by.the U.S. Securities and Exchange Commission would (i) negotiate with the managers of professionally-managed private funds to allow the fund of funds' investment in such professionally-managed private funds if the professionally-managed private funds normally do not permit nonaccredited investors to invest and (ii) assist the manager of the professionally-managed private funds in complying with applicable securities regulations.

22. A method by which a broker-dealer protects confidential information of companies for which it undertakes privately placed securities offerings through a server-based private network of potential investors, comprising the steps of:
a. through its server, a broker-dealer requiring prospective investors to (i) agree to the terms of a confidentiality agreement in favor of it and the companies for which it offers securities; (ii) supply the broker-dealer with information regarding specific companies for which the investor works or holds an executive or equity position; and (iii) supply the brokerdealer with information regarding specific industries in which the investor works or holds an executive or equity position; and
b. through its server, a broker-dealer deny access to those investors who, based on the information provided to the broker-dealer in step a, the company offering securities requests be denied access to information regarding the company and its securities offering.

23. A method by which a broker-dealer undertaking securities offerings through a server-based private network of potential investors reduces transaction costs by debiting investment funds directly from investors' bank accounts, comprising the steps of:
a. through its server, a broker-dealer requiring prospective investors to supply the broker-dealer electronically with its bank account and routing information; and
b. through its server, a broker-dealer requiring prospective investors to authorize a transfer of the applicable purchase price from the buyer's account to the broker-dealer's account.

24. A method by which a broker-dealer undertaking securities offerings through a server-based private network of potential investors transmits video attachments promoting such securities offerings via email and other means of electronic communication, comprising the steps of:
a. through its server, a broker-dealer collecting from prospective investor's email address;
b. through its server, a broker-dealer sends email communications promoting the securities offering to its registered prospective investors; and
c. the email communications promoting the securities offering described in step b with email communications containing a video clip including such features as management presentations and information about the company offering securities.

25. A process of private equity portfolio valuation, comprising the following steps:
a. as each investor in securities issued by a broker-dealer purchases securities through online privately-placed securities offering and purchases and sells securities pursuant to an online resale market, the broker-dealer, through a server, updating a database tracking the investor's portfolio of securities; and
b. the broker-dealer, through a server, then placing an estimated valuation on the portfolio that is based on (a) the initial valuation as used in a companies' initial securities offering, (b) valuations in subsequent securities offerings, reported by companies in connection with information collected and disseminated in the online resale market, and (c) valuations inherent in the prices reported in the online resale market itself.

26. A method by which a broker-dealer undertaking securities offerings through a server-based private network of potential investors promotes competition among individual investors and investment clubs for investment performance, comprising the following steps of:
a. a broker-dealer assisting investors in organizing investment clubs; and
b. using a process of private equity portfolio valuation so that the broker-dealer, through a server, ranking participating individual investors and investment clubs by performance.

27. A method by which a broker-dealer undertaking securities offerings through a server-based private network of potential investors can reduce customer acquisition costs associated with increasing such a private network by issuing its own securities to persons and entities joining and investing through the private network, comprising the following steps:
a. a broker-dealer registering a securities offering of its own securities or obtains exemption from state and federal registration requirements;
b. the broker-dealer organizing a promotion in which members and prospective members of its online investor network receive securities issued by the broker-dealer in exchange for actions which promote the online investor network.

28. A method by which a broker-dealer undertaking securities offerings through a server-based private network of potential investors responds to inquiries from potential investors within this network related to such securities offerings, comprising the following steps:
a. as prospective investors in securities offerings being undertaken by a brokerdealer through online privately-placed securities offerings, the broker-dealer, through a server, allows said prospective investors to send questions regarding such securities offerings and the applicable companies;
b. the broker-dealer drafts responses to such questions and responds to the investors posing the questions by email or other electronic communications;
c. the broker-dealer then collects and categorizes questions and answers and posts them in a periodically-updated document made available via a server and Web site or communicated by email or other electronic means to interested potential investors; and
d. if a potential investor asks a question that the broker-dealer has already answered, the broker dealer refers the potential investor to the previously asked question and corresponding response.
